(19) United States
(12) Patent Application Publication
(10) Pub. No.: US 2012/0303418 A1
(43) Pub. Date: Nov. 29, 2012

(54) DYNAMIC PRICING OF ACCESS TO CONTENT WHERE PRICING VARIES WITH USER BEHAVIOR OVER TIME TO OPTIMIZE TOTAL REVENUE AND USERS ARE MATCHED TO SPECIFIC CONTENT OF INTEREST

(76) Inventor: Illan POREH, Miami Beach, FL (US)

(21) Appl. No.: 13/404,957

(22) Filed: Feb. 24, 2012

Related U.S. Application Data
(60) Provisional application No. 61/488,850, filed on May 23, 2011.

(51) Int. Cl. G06Q 30/02

(52) U.S. Cl. 705/7.35

(57) ABSTRACT

Computer-implemented systems and methods that provide dynamic, essentially real time pricing of users' access to content represented by articles where the pricing varies over time with user behavior to reflect the actual values that users place at any point in time on access to the articles.

### REFERENCE TO RELATED APPLICATIONS

This patent application claims the benefit of the filing date of provisional patent application 61/488,850 filed on May 23, 2011, and incorporates the content of the provisional application by reference.

### FIELD

This patent specification pertains to providing users with access to content, and more particularly relates to a unique method of providing users with access to content at prices that dynamically vary with user behavior over time both before and after content is made available. This new method and system set initial prices that reflect system knowledge of past user behavior and other parameters, and thereafter update prices which can be essentially in real time, as users request or gain access. Users access specific content (e.g. news items, topics, audio visual material, etc.) at the time needed or desired, at relatively low prices per access. Total revenue from content increases because pricing more accurately reflects actual value to users compared to known content distribution systems.

The system and method described in this patent specification provide an e-commerce marketplace for media content that matches users' interests and demands with content provided by publishers—and at the same time determine the values of each content item with a dynamic pricing technology. The system allows users to receive the news or other content that they need at any given point in time essentially directly from the publishers, creates instant demand for additional news and analysis or other content, and provides publishers with a new, sustainable and growing source of revenue. The system is a model of price variation over time of content instruments that can, among other things, be used to determine the price of any article of news and analysis or other content at any given time point. The model assumes that the demand and matching of users with content publishers follows a statistical distribution with predictable drift and volatility. When applied to content, the model incorporates thousands of rules determining the dynamic value variation of the content, based on parameters such as location, purchasing power of users, demand distribution, rating of content and publishers, and time value correlated with the demand. A goal can be to maximize the value of any content at any given point in time.

### BACKGROUND

A number of methods are in use for receiving, pricing, and distributing content. The general categories are subscriptions such as for newspapers, magazines or access to database servers, fixed price for access to individual items such as songs and books, and free access. The content owners may derive revenue from subscription fees, from the fixed fees for access to individual items, from advertisements attached to the content, or from some combination of the foregoing. One example is content from freelance journalists, who may offer an article to an entity such as a publication or a website and negotiate prices by telephone, email or on-line. The entity may edit and publish the article on paper and/or may offer it on a website to paying subscribers, or for free. Several national newspapers and magazines currently have such systems in place, e.g., The New York Times and The Financial Times. Another example is scientific journals that sell their hard-copy publications by subscription or through newsstands but also offer individual articles on websites or as reprints for a fixed fee per article. Elsevier is said to publish over 2,000 scholarly journals and distributes them by subscription, although in some cases it charges a generally fixed price for access to a specific article. Yet another example is subscription services such as Bloomberg or Reuters that offer various levels of access to databases that are frequently updated, at fixed monthly or other periodic subscription prices. Other systems price individual content items for download, such as the Apple Store and Amazon.com for music and books. There are numerous variations and combinations of these known arrangements. All can be useful but all also have limitations and disadvantages. For example, typical arrangements for freelance journalists may take significant time to negotiate terms between the publication and the journalist, and may not accurately account for the value that readers will place on the article or for the value of the content of the article at various points in time. Scientific journals typically set a relatively high price for downloading an article, e.g., $10-$30, and that price may remain the same for articles that have different values to users at different times, so again the price may not accurately reflect the value of the articles at various points in time. Services such as Bloomberg and Reuters typically have high subscription fees, may offer limited scope of content (such as news regarding certain stock exchanges but not others), and may not be cost-effective for users who may be interested in only a narrower field of material at a given point in time or may not be frequent users. Entities such as the Apple Store and Amazon.com also tend to provide content at prices that generally remain fixed for any one item and may not accurately reflect the value of content to users at various points in time or optimize the entity's revenue from all content items.

The system and method described in this patent specification are directed to overcoming these and other shortcomings of known systems by providing a unique new pricing access to content and an overall approach to receiving and distributing content at access prices that are relatively low but are designed to accurately reflect the real value of the content at any point in time, and to increase the cumulative revenue from such content and/or achieve other goals by taking into account actual values that users place on specific content at any point in time.

### SUMMARY OF THE DISCLOSURE

The system and method described in this patent specification may be implemented in different manners depending on system designers' goals and preferences. While specific examples are described below, they are only examples and persons skilled in the relevant technology will appreciate that the disclosed system and method are not limited to those examples but encompass many other examples of implementation.

It may be helpful at the outset to explain several terms used in this patent specification.

The term “content” is used herein to refer to anything that comprises or represent informational content and includes, as non-limiting examples, written material such as news reports, analysis, and interviews, etc., and audio visual information such as speech, music, video, and still images, etc.

“Article” is used as shorthand notation for any content, including without limitation a news article or a scientific article, a recorded video, a live video, a prerecorded audio, a live audio, a recorded musical performance, a live musical performance, a photograph, an interview, a question-and-answer exchange, or any other representation, in whatever form or format, that has informational content.

“Publisher” is used as shorthand notation for any source of content, whether a journalist working as an employee of a publication, the publication itself, a freelance journalist, an author of a scientific paper or article, a music performer, a video provider, or any other source or provider of informational content.

“Lifetime” of an article is used in this patent specification as shorthand notation for a publisher's, a journalist's or the system's expectation or estimate, at any given point in time, of the remaining time period during which users of the system would be willing to pay to read, view or download a specific article.

“Script” is used in this patent specification as shorthand notation for computer-implemented rules or sets of rules that are applied to information to determine or estimate the price of access to an article at a given point in time. A script can be implemented in a specific example of the system as a computer instruction, as a program module or submodule, or in any other manner that serves the intended purpose.

“Server” is used as shorthand notation for a computer facility comprising hardware and/or software and/or firmware that is intended to host applications and carries out the service functions described in this patent specification. When in the singular, the term as used herein encompasses the use of a single server or two or more servers, in each case in the same location or in different locations. Conversely, when this patent specification refers to different servers, their functions may be carried out in a single physical server or in physically separate servers.

In a non-limiting and simplified example of the system and method described in this patent specification, a publisher such as a freelance journalist interacts with the system in an automated process to supply an article and possibly certain information about the article. For example, the journalist signs on with the system electronically via the Internet or through some other link to a system server, uploads basic information such as the article's headline and the content of the article, and perhaps a synopsis and/or some key words from or about the article, the article's genre, the pay that the journalist would like to receive for the article or the value the journalist assigns to the article, and a time period over which the journalist expects users would be willing to pay to read or download the article. As a simplified example, suppose that a journalist has learned about an oil discovery in a remote field in Nigeria. The journalist signs onto the system via an Internet or another electronic link and uploads the article and basic information about the article reporting the oil discovery, setting $1,000 as the value of the article that the journalist proposes (on the belief that the article has medium importance) and setting 4 hours as the article's total lifetime (on the belief that the article is expected to be stale news after 4 hours because then users can learn about the discovery from other sources for free). As another simple example, a journalist reporting an extraordinary interview may set the assigned value at $50,000 and set the total lifetime at 30 days.

The article and initial information that pertains to the article and possibly to the publisher undergo initial processing in the system server to reformat the information and possibly make substantive changes and additions. For example, the system server may add keywords, associate the article with different or additional genres, and set an initial value of the article that is different from the value that the publisher provided, or make other changes or additions. The system server may also add information that uniquely identifies the article, such as an article index and a time related to some event in the processing of the article such as the time the article is received or posted in the system.

The article and the initial information about it that the publisher provided, as modified or added to by the system server, are delivered to a computer-implemented database server. The database server contains similar information for many articles, perhaps hundreds of thousands or millions of articles, and also contains system information such as data regarding the number of users of the system that are currently on line, the number of users who have previously purchased past articles that have some similarities with the specific article, the number of users who have purchased access to the specific article, where such users are located, and other data that may assist in processing and/or pricing the article and/or the users' access to the article.

A dynamic pricing engine receives information about the article from the database server and possibly from the system server, determines initial pricing of access to the article, and then repeatedly reassesses and as needed changes from time to time the pricing for access to the article as well as the rules the pricing engine uses to assess and reassess and set and reset pricing. For example, the pricing engine associates each article with one or more respective scripts that act as sets of rules for determining a current price for access to the article, which price may change up or down during the lifetime of an article depending on various factors or parameters. The parameters that the scripts use to determine a current price for access to an article may include, without limitation, the history of access to articles in the same or similar genres or on the same or similar topics, the number of current and potential users of the article, the distribution of such users by country or region, the time of day in various locations, the location to which the article pertains, and many more.

A script server provides the pricing engine with scripts, associates the article with one or more scripts, and changes the scripts associated with the article as needed from time to time. The script server may have provided hundreds or thousands of scripts, and may change them from time to time or delete scripts or add scripts or change the set of scripts associated with a specific article from time to time.

As a simple example, the system may determine in an automated process that the total desired revenue from the article about the oil discovery in Nigeria should not be the $1,000 that the journalist desires or proposes but should be set initially at $1,800 (or $700). The system may make this determination based on factors such as the number of users that are currently signed on the system, the number of users who have historically bought articles about oil discoveries in general and/or in Nigeria in particular, prices that users have paid for access to similar articles, cumulative revenues previously collected for access to similar articles and/or other rules, factors and parameters. Further, the system may automatically determine that the initial lifetime of the article should not be the 4 hours that the journalist has proposed but 8 hours (or 2 hours), based on similar or different rules, factors and parameters. Based on such processes, the system may set an initial price for access to the article, for example, at $0.10 to read the article and a further $0.05 to save or forward the article, or some other price or a set of prices for access to the article, and possibly prices for purchasing greater rights to the article.

Importantly, the pricing engine does not keep these prices static throughout the lifetime of the article, except possibly in unusual cases, but dynamically varies them in a process seeking to achieve goals such as increasing the cumulative revenue from users' access to the article and/or other goals. For example, the pricing engine may reassess the price of access to the article periodically as pertinent rules, factors and parameters change, such as every few seconds or minutes or even after each fraction of a second, or at selected irregular time intervals. As a simple example, if rapidly increasing numbers of users have accessed the article in the last few seconds, the pricing engine may increase the access prices from $0.10 to read the article and a further $0.05 to download it to $0.14 and $0.07, respectively. In the next iteration, the number of users accessing the article may have dropped during the immediately preceding time period or some other events may have been processed by the scripts that suggest lowering access prices, and the pricing engine may reduce the article access prices accordingly. The pricing engine may set a single price for reading and for saving or forwarding an article, or may change only one of the prices and not the other, depending on the script rules and the current input to the rules. Alternatively, or in addition, the pricing engine may reassess the price(s) for the article when some significant event occurs, such as if the current number of users accessing the article exceeds a threshold or falls below a threshold, or if another important event has been reported that has a likely bearing on the price that users would be willing to pay for access to the article. Finally, the pricing engine may allow free access to the article when the article's lifetime is over. The execution of the scripts associated with the article may advance or delay the time of making the article available to the system users for free, for example because the article continues to generate high interest and is being accessed by many users willing to pay for access, or may shorten the article's lifetime if there has been no significant interest in the article or if its content has become stale news earlier than expected.

The pricing engine may be configured to price access to articles in other modes as well, instead of or in addition to the mode identified above. One of these modes can be the exclusive or non-exclusive transfer of the article to another entity. For example, a newspaper may make arrangements with the system to bid for purchasing articles through the system's automated processes. The bid can be for an exclusive purchase, in response to which the pricing engine determines a price for the transfer on the basis of an automated calculation taking into account various factors according to scripts pertaining to the article and the bidder and, if the seller accepts that price (or the bid is otherwise acceptable to the system) the pricing engine may discontinue offering access to the article to other users, or may offer access to users on terms agreed with the purchasing entity. Or, if the bid is for a non-exclusive transfer, the pricing engine may undertake similar price processing for the transfer, but the access for other users or some categories of other users would continue and the price for such access may reflect that there was a transfer to a purchaser such as a newspaper. Or, there may be a standing arrangement between the system and a newspaper, a magazine, a news service or some other entity for pricing such transfers, in which case there may be no need to determine a special price for each such transfer.

In one example of an embodiment, the system offers access to channels of articles, where a channel may relate to a topic or to a search query. For example, one channel can relate to Nigerian Oil, another to Apple Products, another to Russian Politics, another to stock market news about the Medical Device Industry, etc. Some channels may be pre-selected by the system and presented to all users, e.g., for topics that are likely to be of interest to many users. Other channels may be created solely in response to designations of search queries from specific users and include only articles that meet their narrow designations or search criteria. The channels accessible by a particular user may be active channels that are continually updated with articles in the topic of the channel and are immediately available to the user, or inactive channels that are saved for that user and can be stored and made available upon some later action by the user.

In one example of an embodiment, the system provides access to several different categories of users on different terms. One category is free users, who pay nothing but gain access only to a portion of the articles in the system and/or only after a delay, such as 20 minutes after the articles were posted in the system, have access to only a limited number of active channels (e.g., 18) and no inactive channels. A second category is pay-per-view (PPV) users, who have made financial arrangements with the system, such as by registering with credit cards or creating some other accounts that the system can charge for access to priced articles, and have free access to articles that are not priced (i.e., articles that can be accessed for free, for example because their lifetimes are over). PPV users have access to priced articles after a shorter delay (or no delay), such as 10 minutes after the articles were posted, have access to a limited number of active channels (e.g., 18) but also to a limited number of inactive channels (e.g. 18), and can post comments and questions on both priced articles that they have accessed and on free articles. A third category is real time users, who pay a monthly or other agreed fee and, so long as they remain up to date in their financial arrangements with the system, have access to a certain number of active channels (e.g., 18) and inactive channels (e.g., 36), can access articles with no delay, and can post questions and comments on the articles they access. Another category of users is the publishers themselves, who can access the system to post articles as discussed above and also can access other articles on specified terms. The publisher-users can be in a single category regarding access to articles, with one type of financial arrangements with the system for access to articles, or in several categories that provide different terms for access to articles. For example, a particularly valued publisher may be given access similar to that for real time users, while another publisher may be given more limited access. These categories are only examples, and another specific implementation of the system described in this patent specification may use different categories with different attributes, and/or a different number of categories, or even a single category.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.”

FIG. 1 illustrates an overall arrangement of a system for receiving, pricing and distributing content according to one example of the system and method described in this patent specification.

FIG. 2 illustrates an example of a webpage that the system downloads to a screen of a free user.

FIG. 3 illustrates an example of a screen that the system downloads to a pay-per-view (PPV) user.

FIG. 4 illustrates an example of a screen that the system downloads to a real time user.

FIG. 5 illustrates an example of a synopsis view for an article that opens in response to a user interaction with the system.

FIG. 6 illustrates a cascade of articles that a user has opened (accessed).

FIG. 7 shows in magnification article tabs that appear in the display of the open article seen in FIG. 6.

FIG. 8 illustrates an example of another magnified portion of the FIG. 6 display.

FIG. 9 illustrates an example where an article includes not only text but also images.

FIGS. 10a and 10b illustrate examples of a publisher's interaction with the system.

FIGS. 11a through 11f further illustrate examples of a publisher's interaction with the system

FIG. 12 illustrates a portion of the system of FIG. 1.

FIG. 13 illustrates the same portion of the system as FIG. 10 but in a different stage of processing the pricing of the article.

FIGS. 14-21 are self-explanatory examples of different stages of the process of pricing an article in the overall system of FIG. 1.

FIG. 22 is a flowchart illustrating an example of a publisher's interaction with the system.

FIG. 23 is a flowchart illustrating an example of steps in the operation of a pricing engine.

### DETAILED DESCRIPTION OF PREFERRED EMBODIMENTS

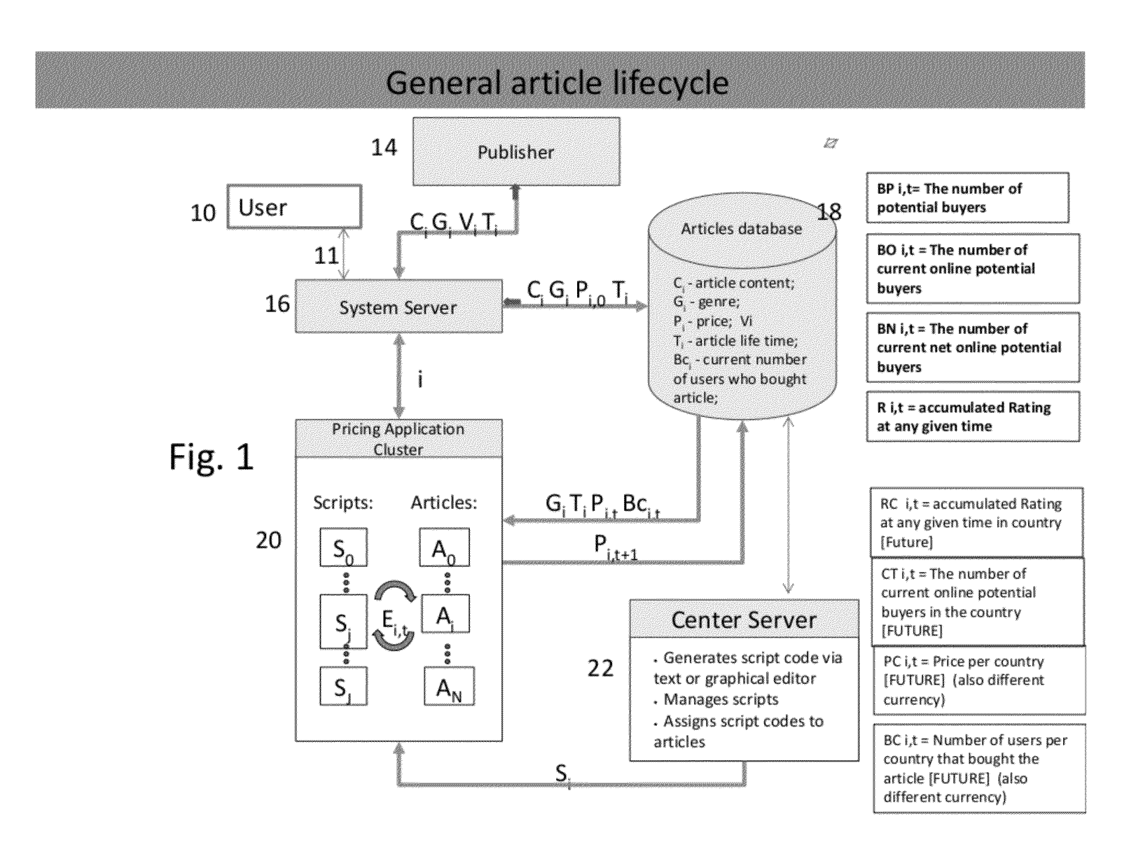

Referring to the illustration in FIG. 1 of a non-limiting example of a system and method for receiving, pricing and distributing content, consider the example of a publisher 14, for example a freelance journalist. The journalist is at a location remote from the system and uses a connection mechanism such as personal computer, a tablet or some other device to establish two-way communication with a system server 16, for example using a browser and the Internet. System server 16 downloads to the publisher's device a screen display through which the publisher navigates and selects actions such as signing on the system, creating an account and/or a profile, changing settings, selecting or creating an active channel or accessing an inactive channel, submitting an article and information pertaining to the article, accessing other articles (and questions or comments thereon), uploading to the system answers to questions posted by others, commenting on articles, etc., and signing out. A typical input that a publisher provides when submitting an article identified by an index i (where i can be a unique number associated with the article) comprises the article content Ci, analysis information such as a genre Gi of the article and a synopsis of the article and keywords from or about the article, a value Vi that the journalist proposes for the article, and an initial lifetime T1 that the journalist proposes for the article. System server 16 receives this information and subjects it to initial processing. For example, based on other information and on rules applied by the operation of computer programs in system server 16, the system server sets an initial price Pi,o for access to the article, and may change the genre Gi and the keywords associated with the article, and may change the value Vi and the initial lifetime T1 that the journalist proposed to a higher or lower value and/or a shorter or longer lifetime.

System server 16 delivers the article and the processed information about it to an articles database server 18, which stores the information with the appropriate identification index i together with many other articles and the information associated with them. Each article can be designated as article Ai, where i=0, 1, 2, . . . , N, and N can be a very large positive integer. As one example, articles database server 18 initially stores the article content Ci, the articles genre Gi, the article's price Pi (which at time t=0 may be the initial price Pi,o determined by system server 16), and the article's lifetime T1. In addition, articles database server 18 stores information about the state of the system, such as the current number BCi of users who have bought access to the article Ai (this number may be zero or a selected non-zero number before any access), and the number Bo of users who are on line in the system at time t=0. Articles database server 18 updates BCi as users access the article, using information that is generated as discussed below in connection with the way publishers/users access articles. System server 16 may use information from article database server 18 in setting the initial price Pi,o for access to the article, for example by calculating Pi,o=Vi/Bo, or by applying a more complex set of rules to calculate Pi,o that may take into account factors such as history of the publisher, history of similar articles, the time and date of publication, the nature of the topic, etc.

In a specific example of the system and method described in this patent application, articles database server 18 supplies, for each article Ai, the information Gi, Ti, Pi,t, and BCi,t to pricing application cluster 20, which together with script server 22 forms a pricing engine. The first time information about an article Ai is supplied from article database server 18 to pricing application cluster 20, i.e., at time t=0, the parameter Pi,t=Pi,o, and the parameter BCi,t=0 (or some selected non-zero number), but at subsequent times t, BCi,t may be and typically is a growing non-zero number as more users access the article. The parameters for an article then iteratively pass, for each time t, from pricing application cluster 20 to articles database server 18 and back to pricing application cluster 20. The time t can be periodic, e.g., every so many units of time, and/or can be triggered by specified events, or can be reset to a new value at selected irregular intervals of time. In each iteration for time t, pricing application cluster 20 calculates an updated access pricing parameter Pi,t+1 (where the numeral 1 designates a time interval of 1 unit for article Ai), and sends it back to articles database server 18, which will supply that price parameter as price Pi,t back to pricing application cluster 20 for the next iteration. Pi,t can be a single price for access, or plural different prices for respective different types of access.

Importantly, articles database server 18, or another system facility, stores historical information that is useful for initial valuations of articles and initial selection of lifetimes of articles. This historical information can include, without limitation, information on the total numbers of users who have accessed articles, possibly classified by numbers of users who have accessed specific genres and topics and who are potential users of specific articles, possibly per geographical region and per language, and other historical information that has been gathered in use of the system and information, that has been input by operators or administrators of the system in the belief that it may or should influence initial estimates of valuation and of lifetime.

Pricing application cluster 20 is a computer-implemented processing system that stores scripts Sj (where j is an index identifying a script, j=0, 1, 2 . . . , J, and J is a positive integer). Each script Sj is essentially a rule or a set of rules applied to information about articles that are being priced by pricing application cluster 20. Script server 22 generates the script code via text or graphical editors, which may be under the control of system operators or administrators, manages the scripts, and assigns script to articles. In practice, one or more scripts Sj are assigned to each article Ai. Each script assigned to an article and used in pricing the article in pricing application server 20 can be updated by script server 22 so that the updated script will be used during the remaining lifetime of the article and even after the lifetime of the article, unless further updated. Similarly, the assignment of scripts Sj to an article can be updated, so that pricing application cluster 20 applies different sets of scripts to the same article at different times.

Scripts Sj apply to articles Ai rules that use as inputs a set or subset of factors and parameters that script server 22 has determined are useful in pricing access to articles. System server 16 collects and processes information regarding parameters from interactions with publishers 14 and users 10, and stores and updates it in articles database 18 or another system facility, from where it can be supplied to pricing application cluster 20 and/or to script server 22 so that it may be used for each article Ai and each iteration for time t. As illustrated in FIG. 1, these factors and parameters can include the following examples: Bpi,t=number of potential purchasers of access to article Ai at time t; BOi,t=number of potential purchasers of access to article Ai who are currently on line in the system; BNi,t=number of remaining potential purchasers of access to article Ai (i.e., the potential purchasers who have not accessed the article); Ri,t=accumulated rating of article Ai at time t (where the rating can be calculated based on factors such as, but not limited to, the rate at which the article is accessed compared to an average article); CTi,t=number of current potential purchasers of an article in a specified territory T (which can be a country or some other region) at time t; PCi,t=price charged for access to article Ai at time t in a country C (or some other region), if different prices and/or prices in different currencies, are charged for access from different parts of the world or through different access pathways or through different payment arrangements; and BCi,t=number of users who have purchased access to article Ai by time t from a specified country or other region, or paid in a specified currency or through a specified financial arrangement. These are only examples of factors and parameters that can be taken into account in pricing access to an article, and any one implementation of the system and method described in this patent specification can use a subset of these values or a different set of values depending on the choice of the system designers and the goals of the system.

Scripts Sj apply rules to articles Ai to generate a price Pi,t+1 for article Ai in each iteration through pricing application cluster 20. As a simplified example, one rule can be that access price Pi,t+1 is set to ($0.03+Pi,t) if the number BCi of users who purchased article Ai increased by 10 or more users from time t to time t+1 and also increased by 10 or more users in each time interval from t−10 to t, and the net number BNi,t of potential purchasers of access to article Ai increased by at least 5 users in each time interval from time t−20 to time t. Other examples of scripts Sj are discussed below in connection with the pricing portion of the system and method, but it should be clear that any given example of implementation can include different rules depending on the designer's preferences and the goals of the implementation.

While a specific implementation of the system and method disclosed in this patent specification may rely on any number of scripts, and the scripts of one implementation may differ from those of another, typically a great number of scripts would be used. Illustrated below is one example of a script of this type, in a computer language that a person skilled in the pertinent technology would understand:

Lua-Script Code Sample

| Script code | | Script |
|---|---|---|
| If EQ_INIT == 1 then | | Initial |
| | | execution of |
| | | script for |
| | | article |
| | local price = eq_get_value( )/eq_get_pbuyers( ); | Initial price |
| | | is equal to |
| | | Value divided |
| | | by Number of |
| | | potential |
| | | buyers |
| | eq_set_price(price); | Setting of |
| | | initial price |
| | local p0 = | Initial |
| (eq_get_purchases_delta( )/eq_get_pbuyers( ))*100 | | percent of |
| | | users who |
| | | bought article |
| | eq_save_number(“percent”,p0) | Save initial |
| | | percent of |
| | | users who |
| | | bought article |
| | eq_next_call(0); | Scheduling of |

| | | next script |
|---|---|---|
| | | execution |
| | | (immediately) |
| else | | Next script |
| | | executions |
| | if eq_get_execution( ) == 2 then | This code will |

| | | be executed |
|---|---|---|
| | | after 10 |
| | | seconds of |
| | | article |
| | | processing |
| | | (second |
| | | execution) |
| | local lp = eq_load_number(“percent”); | Load percent |
| | | of users who |
| | | bought article |
| | | on previous |
| | | script |
| | | execution |
| | local p = | Current |
| (eq_get_purchases_delta( )/eq_get_pbuyers( ))*100 | | percent of |
| | | users who |
| | | bought article |
| | | (BCi, t/ |
| | | Bpi, t)*100% |
| | if p − lp > 1 then | If number of |

| | |
|---|---|
| eq_set_price(eq_get_price( )*1.2) | users goes UP |

| end; | by 1% then |
|---|---|
| | Increase price |
| | by 20% |
| eq_save_number(“percent”,p) | Save current |

| | percent of |
|---|---|
| | buyers for |
| | using on next |
| | script |
| | execution |
| else | This code will |
| if eq_get_execution( ) == 120 then | be executed |
| | after 600 |
| | seconds of |
| | article |
| | processing |
| else | This code will |
| | be executed |
| | all next times |
| | Code! |
| end; | |
| eq_next_call(5); | Scheduling of |

| | |
|---|---|
| | next script |
| | execution |
| | (after 5 |
| | seconds) |
| end; | |

Pricing API Description

One version can support all functions in a table which are used for all countries (currencies), but other versions can support special arguments to allow set (get) values for specified countries.

For example:

| | |
|---|---|
| eq_set_price(123, “Russia”); | //Set price equal to 123 for Russia |
| local p = 223; | |
| eq_set_price(n,”France”); | //Set price equal to 223 for France |

local list = {“USA”,”Germany”,”Japan”}
eq_set_price(149,list) //Set price equal to 149 for three countries
local pb = eq_get_pbuyers_online(“Italy”) //Get number of online
buyers from Italy

API Description

| | Math | |
|---|---|---|
| Script functions | symbol | Description |
| eq_get_life_time( ) | Ti | Returns full article life time |
| | | in pricing engine(seconds) |
| eq_get_execution( ) | it | Index of script execution |
| eq_get_lived_time( ) | t | Returns time of article which |
| | | it lived in pricing engine |
| eq_get_value( ) | Vi | Return total value |
| eq_get_price( ) | Pi, t | Returns current article price |
| eq_get_trend( ) | Tdi, t | Returns current article trend |
| eq_get_genre( ) | Gi | Returns article genre |
| eq_get_pbuyers( ) | PBi, t | Returns total number of |
| | | potential buyers for article |
| eq_get_pbuyers_online( ) | POi, t | Returns total number of online |
| | | buyers |
| eq_get_article_rating( ) | Ri | Returns article rating |
| eq_get_purchases_total( ) | Bci, t | Returns total number of users |
| | | who bought the article |
| eq_get_purchases_delta( ) | BCi, t | Returns number of users who |
| | | bought the article since last |
| | | script execution |
| eq_save_number(name,val) | | Save some value (val) to |
| | | database with name |
| eq_load_number(name) | | Returns value from database |
| | | which is saved with name |

### Implemented Functions:

eq_get_price( )
eq_get_trend( )
eq_get_genre( )
eq_save_number(name,val)
eq_load_number(name)

Users 10, who are at remote user locations, access articles through a link with the system, for example through web link 11, in a manner similar to publishers (who also can be users). As noted above, there can be different categories of users. Taking the example of a free user and one example of a link, the user signs on through a browser in a personal computer or other electronic device and through the Internet with system server 16, which sends to the user's screen a webpage that identifies the connection as one to a free user, and may include in the screen display at the user's screen information that identifies the user, provides a menu through which the use can upgrade status, may state that the articles are delayed by a specified time interval, may provide a listing of active channels (topics), may provide a filter menu through which the user can create new active channels (e.g. by submitting a search query), may list available articles in the channel that the user designates and the status of each article (e.g. as free, or available for a listed price or by subscription only), and may provide many other items of information to the user.

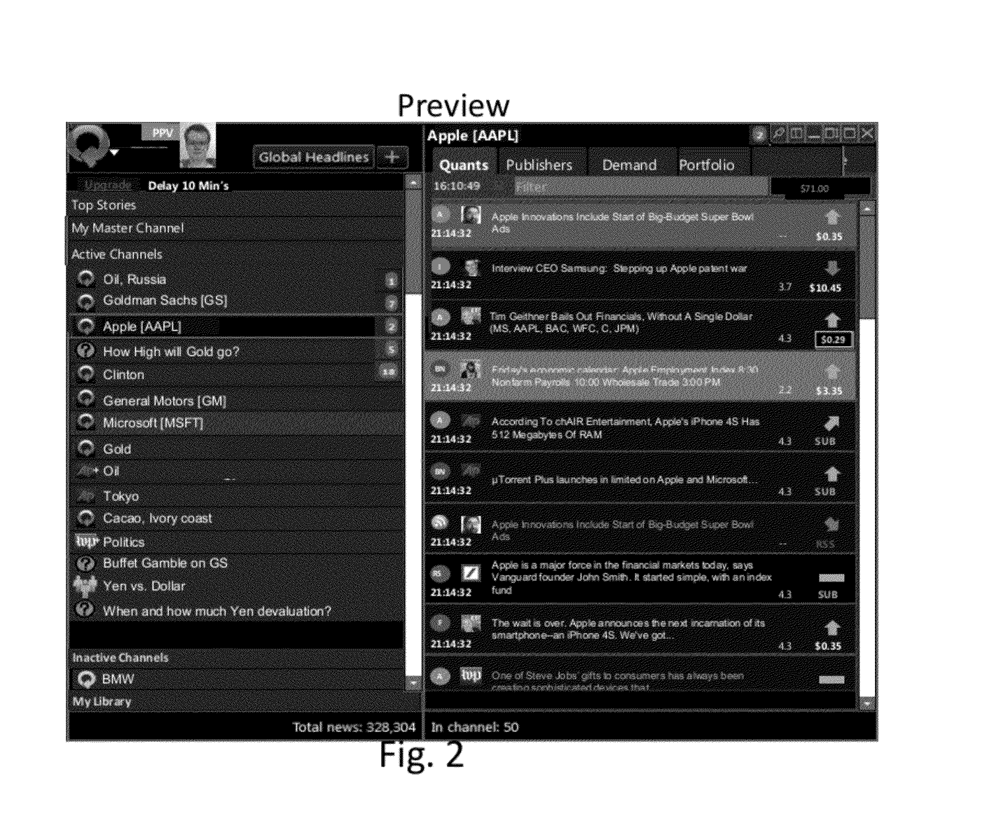

FIG. 2 illustrates an example of a webpage that the system provides on the screen of a free user. The upper left identifies the category of user (“free”) and has a menu item “upgrade” through which the user can upgrade to a different category (e.g., by specifying the desired category and providing credit card information or making other financial arrangements). Through clicking the left column entries, the user can select: Top Stories, in which case the right columns will show a selection of several stories that are the most popular ones at the time; or My Channels, in which case the system will list channels that the user has previously selected; Active Channels, in which case the system will list on the left several active channels as in the illustrated example. Each active channel shows the number of articles that user has not yet read (in this example, the Apple channel has 2 unread articles and the Clinton channel has 18 unread articles). The same number of unread articles shows in upper right when the respective channel is selected and when is updated, and the color of the number is changed when the system posts another article in that channel. To the left of the active channel names are symbols that identify the source of the material, for example Q for the system described in this application and AP for Associated Press (in this example, a publisher such as AP can supply content to the system and method described in this patent specification per financial and/or other arrangement made between AP and the system). To the right of the channels are identifications of the channel that is currently selected (Apple [AAPL]) and a scrollable listing of articles in that channel by title and/or synopsis. The circled symbols to the left of each article title identify the genre of the article (e.g., BN for breaking news) and the source of the article (by an abbreviation such as AP, a picture of the author and/or in some other way). To the right of the article name is information on access rights and on the trend of access. For example, access to the first listed article in FIG. 2 costs $0.35 at the time the page of FIG. 2 is the current version that is being displayed to a user, and the trend is up (i.e., there is increasing interest in the article as pricing application cluster 20 has determined based on current requests for access to the article and/or other factors related to the popularity of the article which system server 16 has tracked). If the free user decides to access this priced article, the user may upgrade status by clicking on “Upgrade” at upper left and proceed through the menu that would appear on the user's screen in response. One article has an arrow that points up at an angle, to indicate a lesser degree of increasing popularity. Comparable arrows that point down indicate different degrees of decrease in popularity of the respective articles. Some articles are identified as “SUB,” meaning that they are available under subscription. FIG. 2 does not happen to illustrate free articles that would be identified by the notation “Free” to the right of the article title. If the user clicks on a free article, system server 16 obtains it from articles database server 18 and downloads it to the user's screen. At upper right are buttons for scrolling, enlarging, hiding, and other operations on the articles. When the portion of the display to the right is detached from the channel listing and moved some distance to the right of the channel listing, there are scroll bars to the right of each portion. When the user clicks on an article, the color changes and a synopsis of the article may be included in the area that is so colored. The titles of articles that the user has already read may be colored differently from other article titles. The lines for breaking news may be highlighted in yet another color.

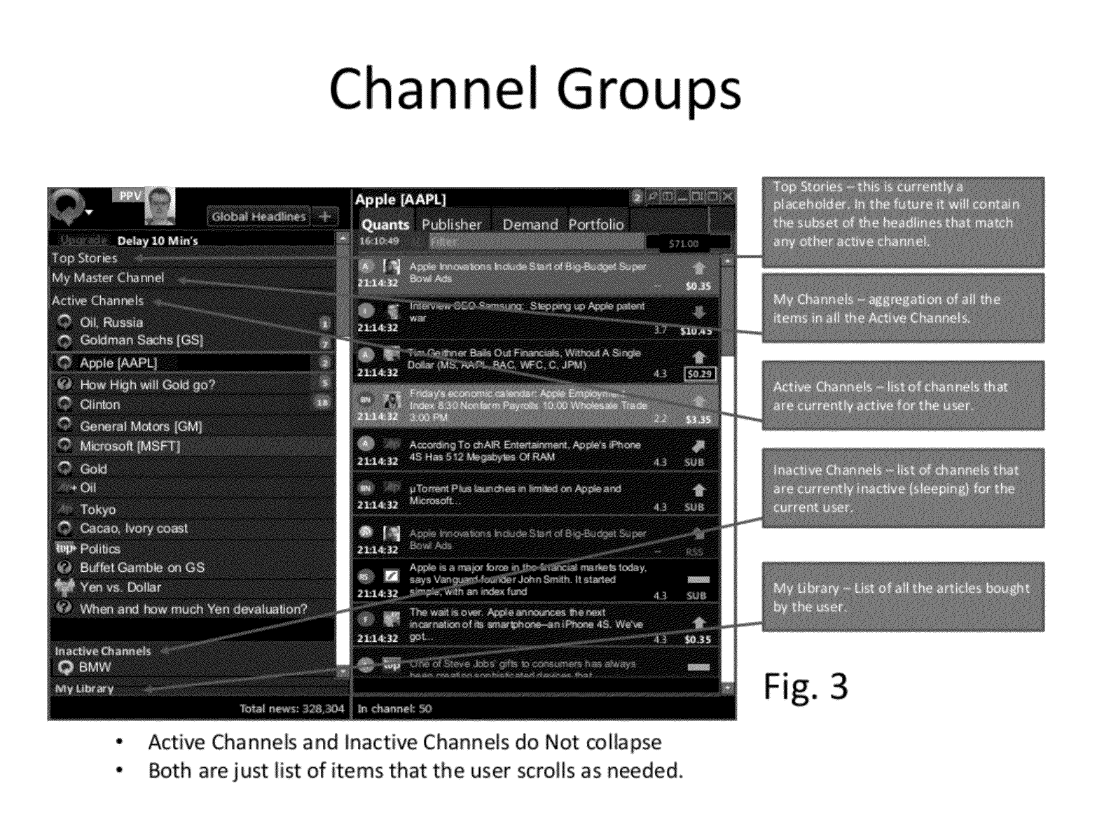

FIG. 3 illustrates an example of a screen that the system downloads to a pay-per-view (PPV) user. It is similar in most respects, but identifies the user as a PPV user and may include the user's picture. In addition to the illustrated active channels, it can include inactive (sleeping) channels. The PPV user can click on the price entry for an article to open the article, in response to which system server 16 download the article to the user and the text of the article is displayed on the user's screen in a new window in the same manner as discussed above for free articles to a “free” user or as discussed below for “real time” or “subscription” users. System server 16, of another facility of the system, charges the PPV user's account for this download and stores the charge information in the system, for example in articles database server 18. As in the case of all categories of users, the user can create a new active channel by entering a search term or query in the box labeled “filter.” The PPV users are charged for access to articles. For example, the user can make arrangements with the system to allow charging the user's credit card for the price of an accessed article, or the user can make a deposit into the system through a credit card or otherwise, in which case the card or the deposit is charged accordingly. Charging systems are known in the pertinent technology and, for the sake of conciseness, are not discussed in detail in this patent specification.

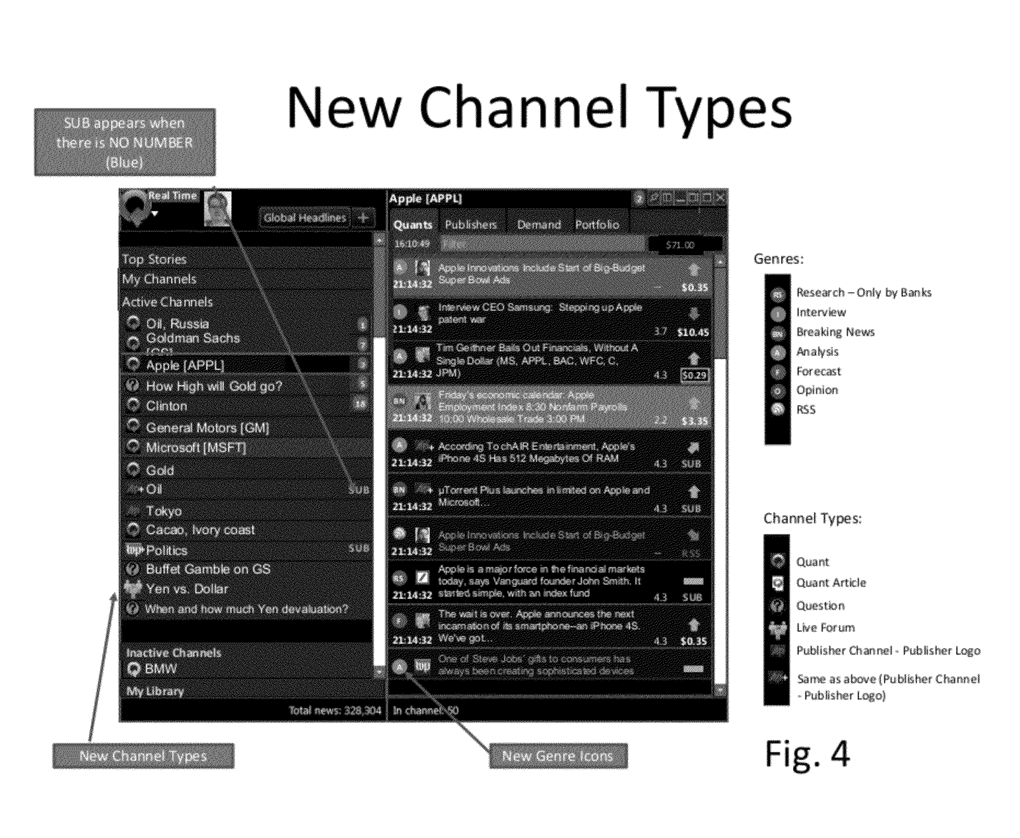

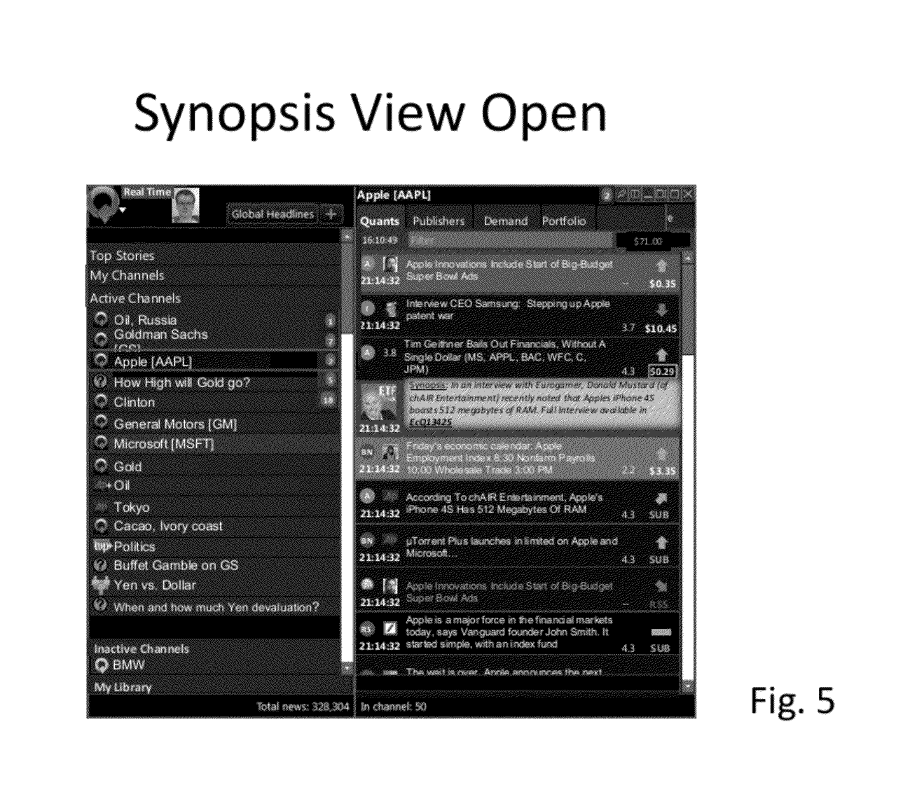

FIG. 4 illustrates an example of a screen that the system downloads to a real time user. Again, it is similar in most respects but identifies the user as a real time user and may show a picture of the user at upper left. As noted above, the real time user can have a greater number of inactive channels and, as in the case of the PPV user, can post questions and comments on the articles. Questions and comments, and answers to the questions that the publisher of the article may provide are visible to all user categories, or only to some of the categories, as determined by pricing application cluster 20. A real time user gains access to article content in a manner similar to that used for a PPV user except that a real time user has access to all articles without delay and does not pay for individual articles (including those for which a price is indicated) from a particular publisher where the real time user has previously paid for a subscription. FIG. 4 also illustrates the genre symbols and channel type symbols and meanings attached to them. FIG. 5 illustrates an example of a synopsis view of an article that opens on a user's screen in response to a user moving a cursor over the article title or clicking for a synopsis view. Again, because systems for making financial arrangements with subscription users are known in the pertinent technology, such as for web access to newspapers, magazines, and data services, a suitable method for charging subscription users need not be discussed in detail.

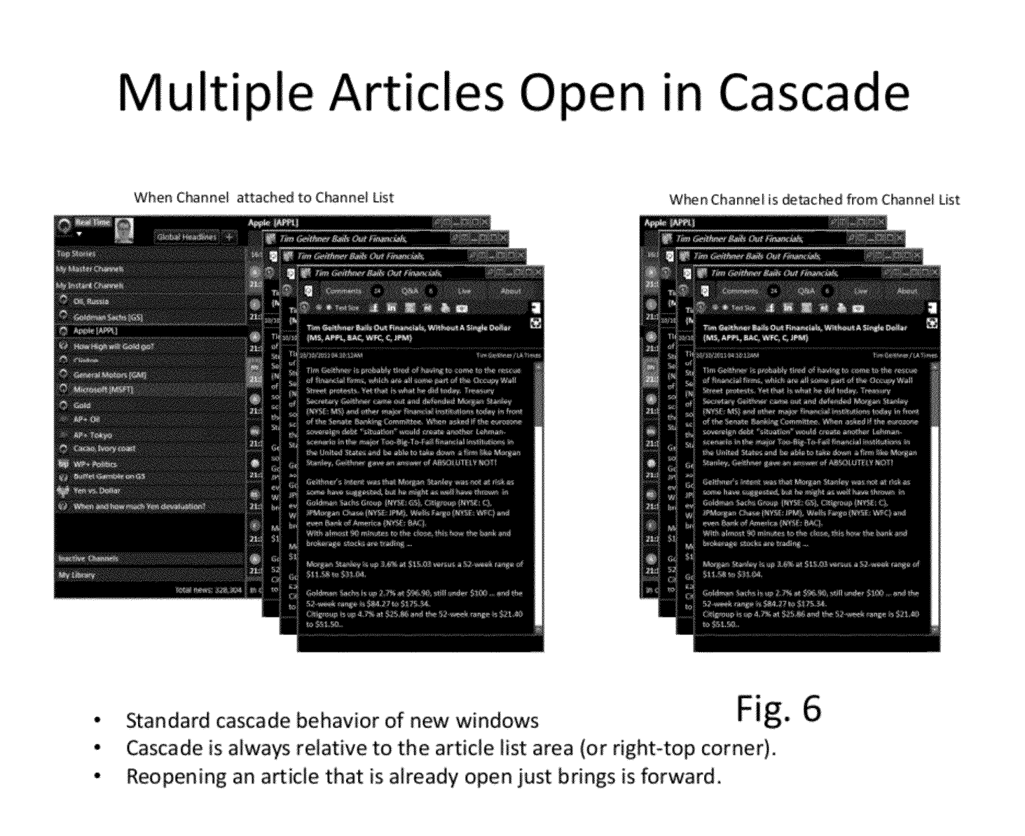

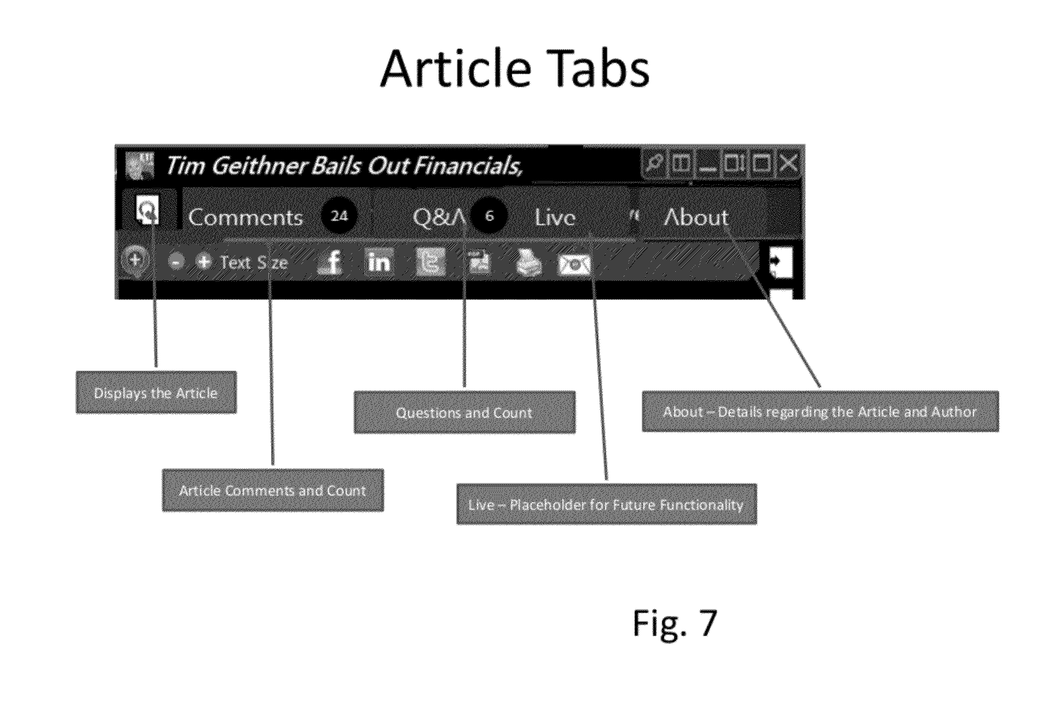

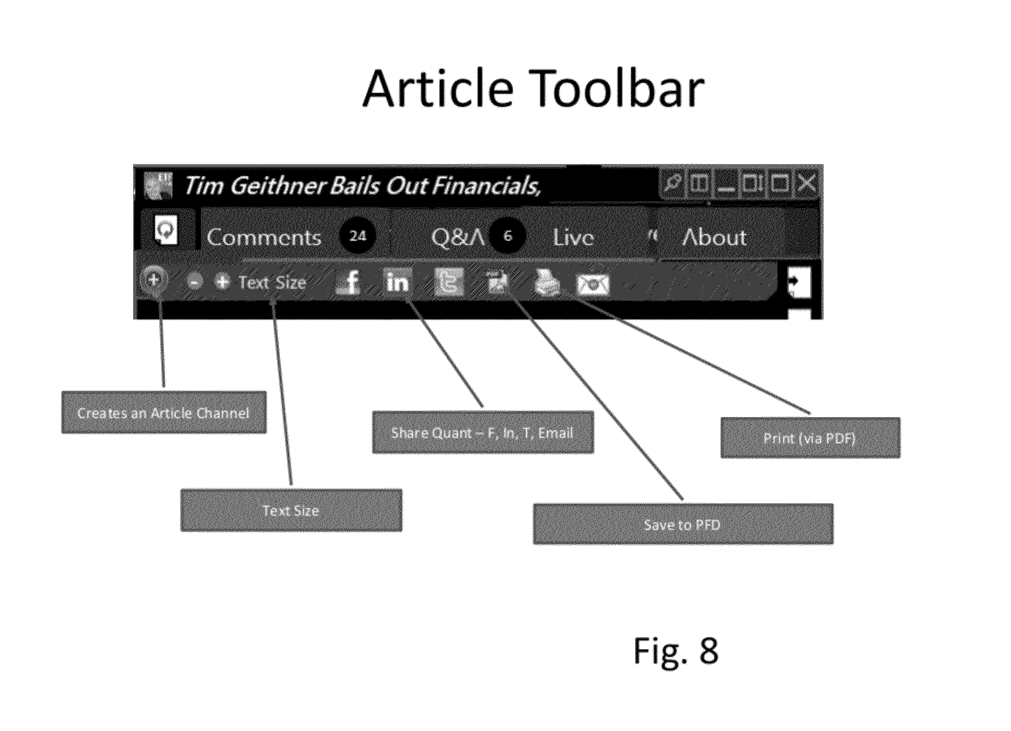

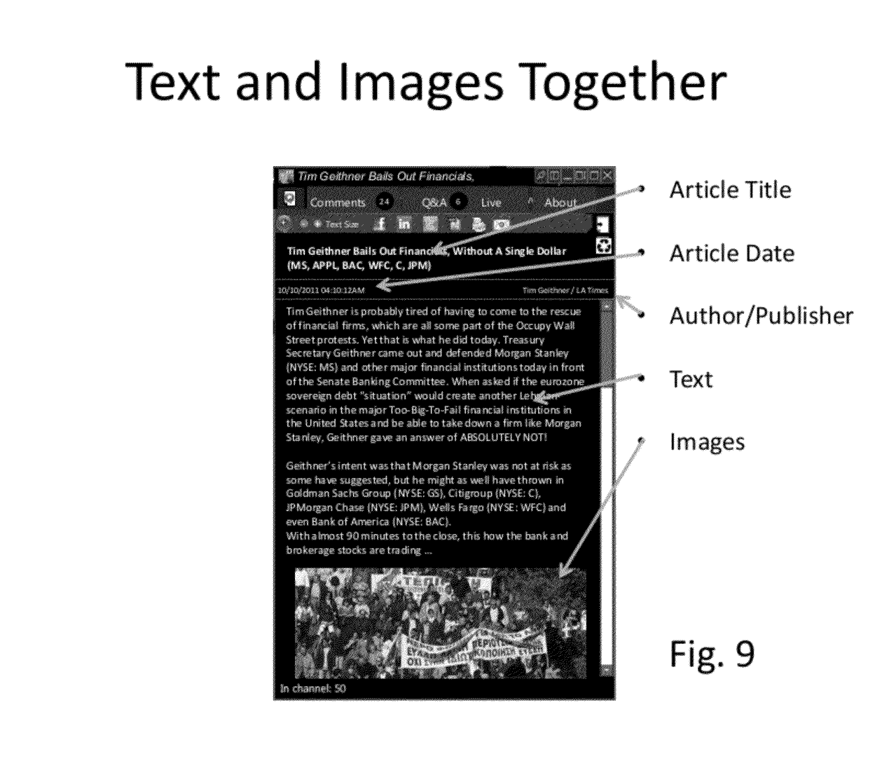

FIG. 6 illustrates a cascade of articles that a user has opened (accessed). If only one article is opened, then of course only one article would appear on the user's screen next to and/or detached from the channel listing. A horizontal middle band of the FIG. 6 screen has been deleted in order to make the remaining text more legible. FIG. 7 shows in magnification article tabs that appear in the display of an open article seen in FIG. 6. In FIG. 7 the display of an open article includes a tab Q for displaying the article, a comment tab for displaying comments about the article that PPV and real time users have posted (24 comments in this example), questions about the article (6 in this example), a Live button for a function such as live chat, and an About tab for the display of details regarding the article and/or its publisher. FIG. 8 illustrates an example of another magnified portion of the FIG. 6 display. As seen in FIG. 8, the display of an open article includes a “+” button that creates an active channel for the user, which active channel is the topic of the article. Buttons labeled “−” and “+” next to the label “text size” enlarge or reduce the text size. Several buttons to the right when activated by the user export the article, such as to a Facebook account, a Twitter account, a Linkedln account, etc. Another button saves the article in the user's computer or other device, in a desired format such as in text format or in PDF format. A print button prints the article, for example in text format or in PDF format. Another button activates an email function for emailing the article to one or more specified addresses. FIG. 9 illustrates an example where an article includes not only text but also images.

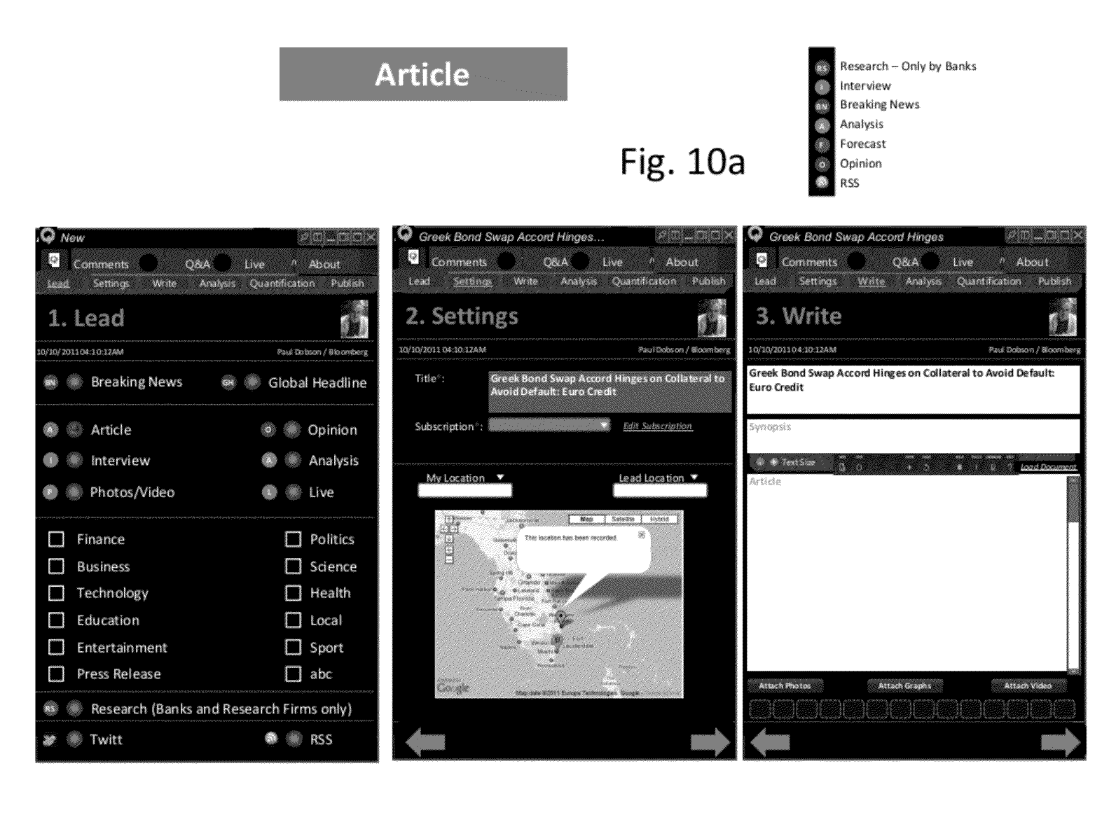

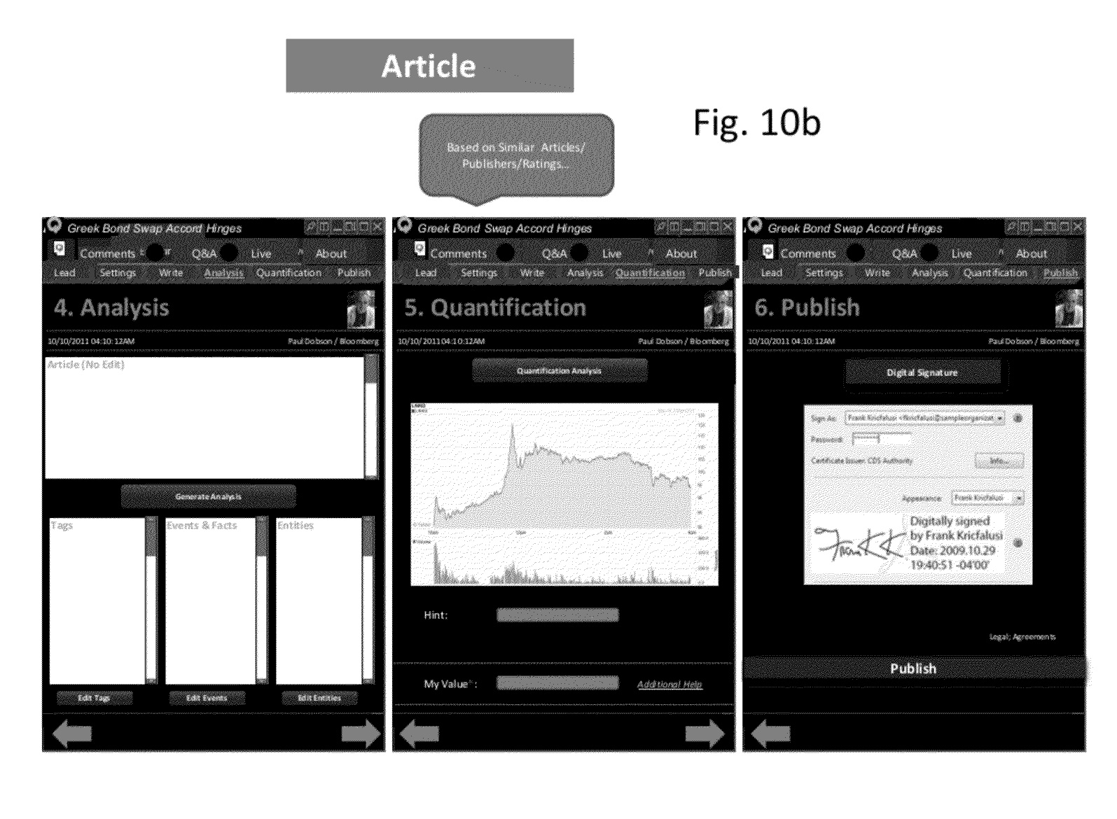

FIGS. 10a and 10b illustrate self-explanatory interactions of a publisher with the system, through which the publisher signs on and provides the system with an article and the information regarding the article as discussed above. As one example, in the screen at the left of FIG. 10a, which contains the heading “1. Lead,” the publisher may enter initial information about the article by checking the appropriate entries, e.g., to indicate that the article is “Breaking News,” its genre is “Opinion,” and it pertains to “Finance.” In the next screen, which contains the heading “2. Settings,” the publisher may enter additional information such as a title of the article and the publisher's location. In the next screen which contains the heading “3. Write,” the publisher writes in a synopsis of the article (if desired) and the text of the actual article, and attaches any photos, video or other material as indicated. FIG. 10b, the next screen, contains the heading “4. Analysis,” where the publisher may enter further information about the article, for example, key words of tags. The middle screen contains the heading “5. Quantification,” informs the publisher the system's estimates of revenue from users' access to similar articles over a specified time interval, and prompts the publisher to assign a money value to the article. The last screen that the system places on the publisher's screen display contains the heading “6. Publish” and provides the system with an authentication of the publisher and the publisher's agreement with the system's terms regarding posting and using the article.

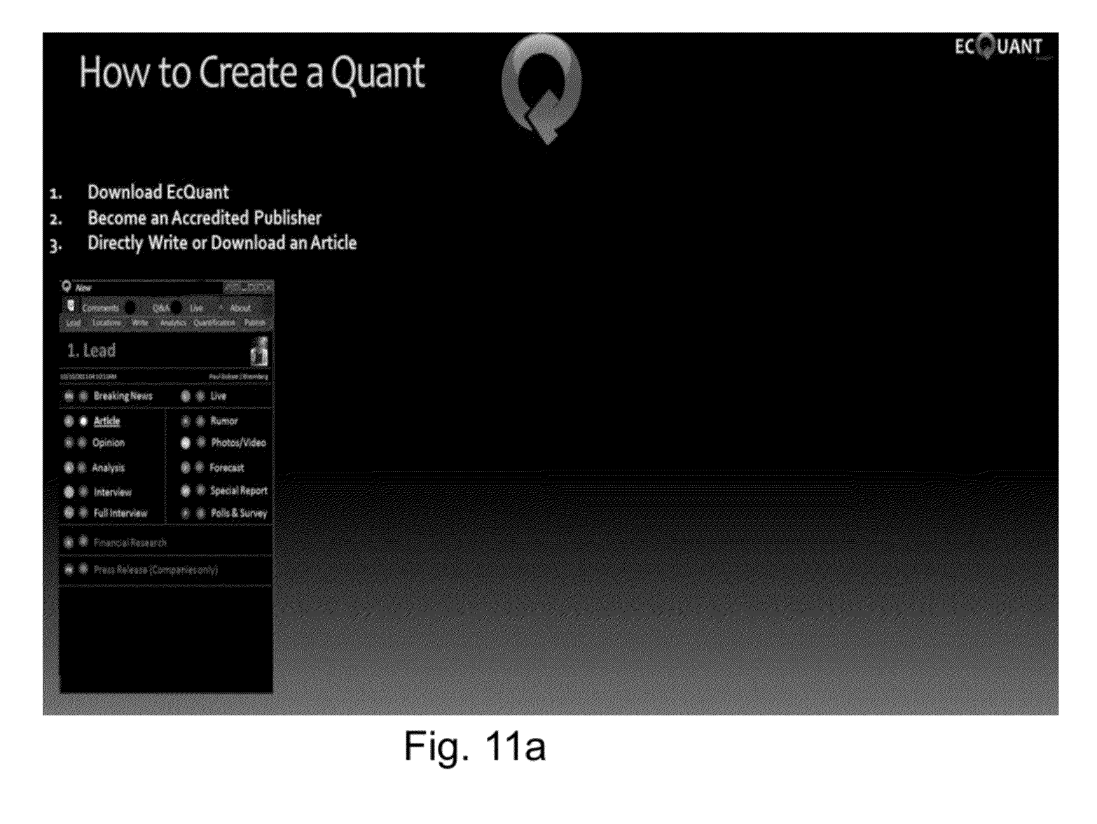

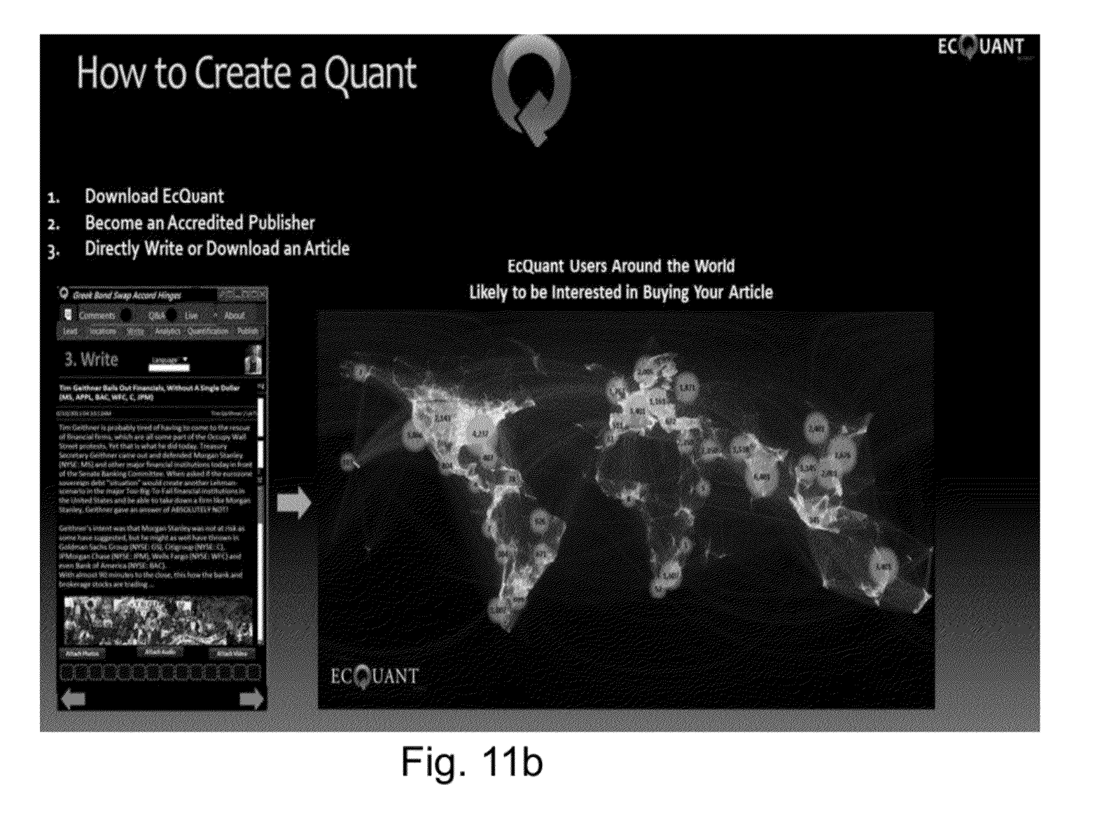

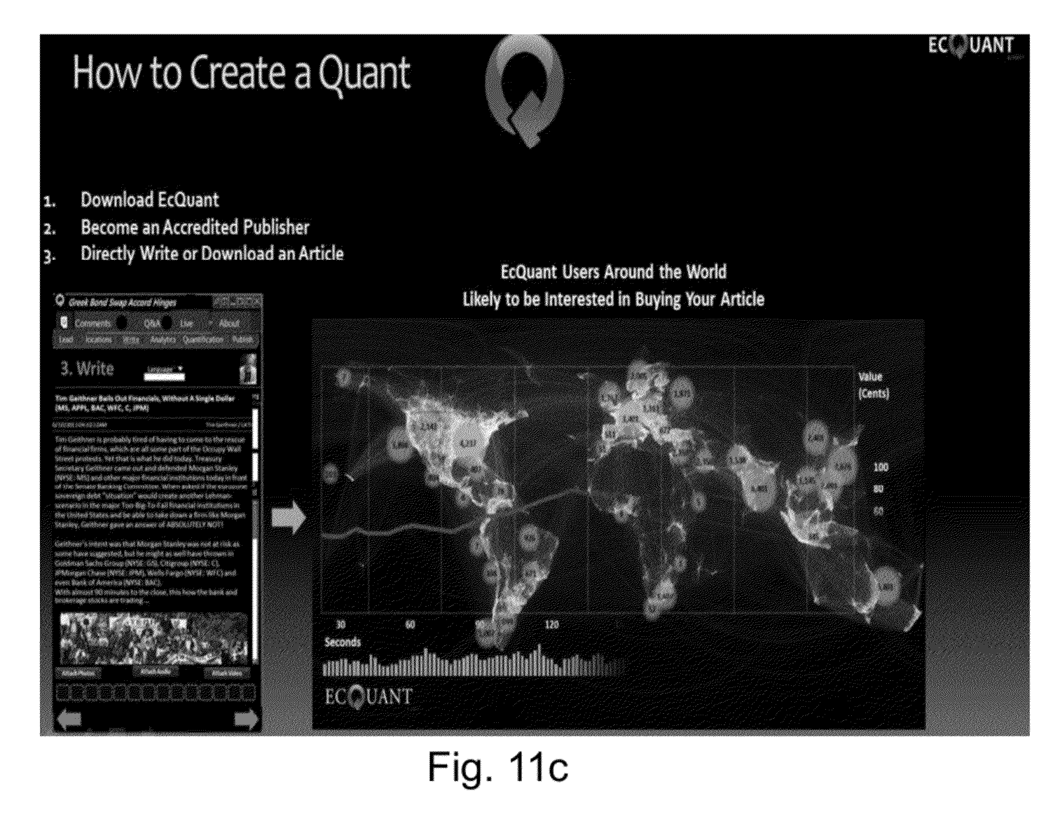

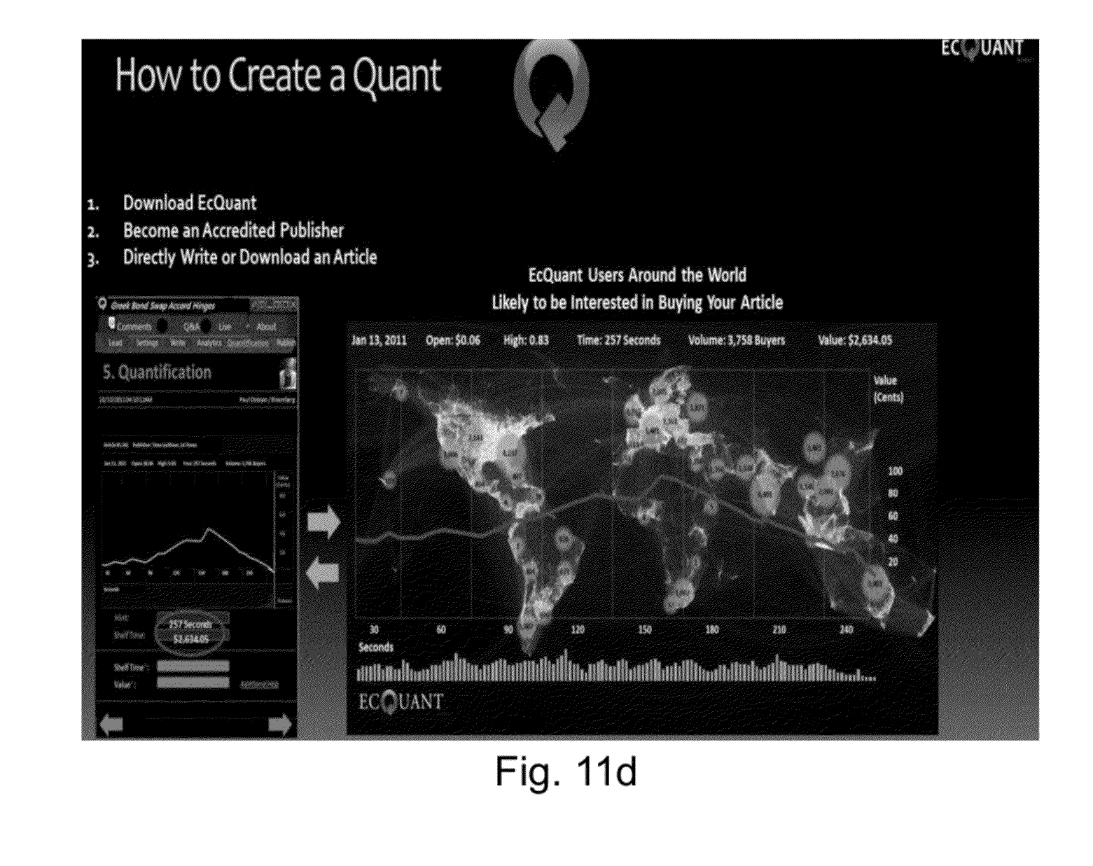

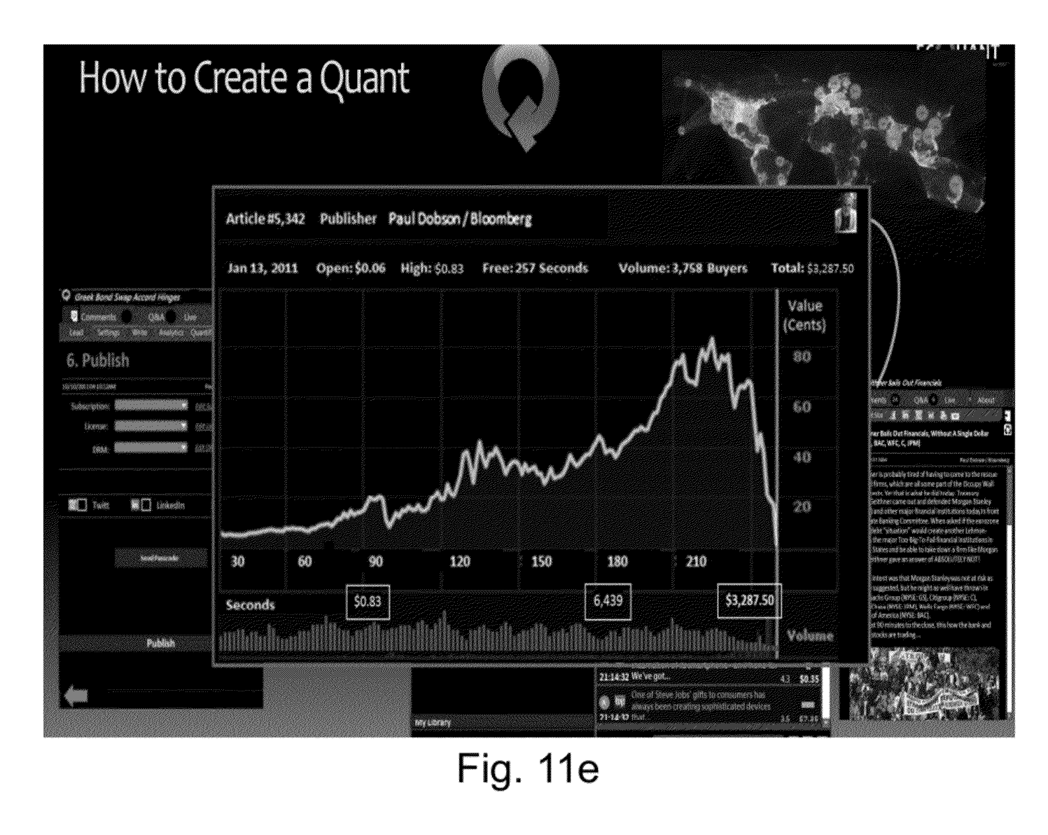

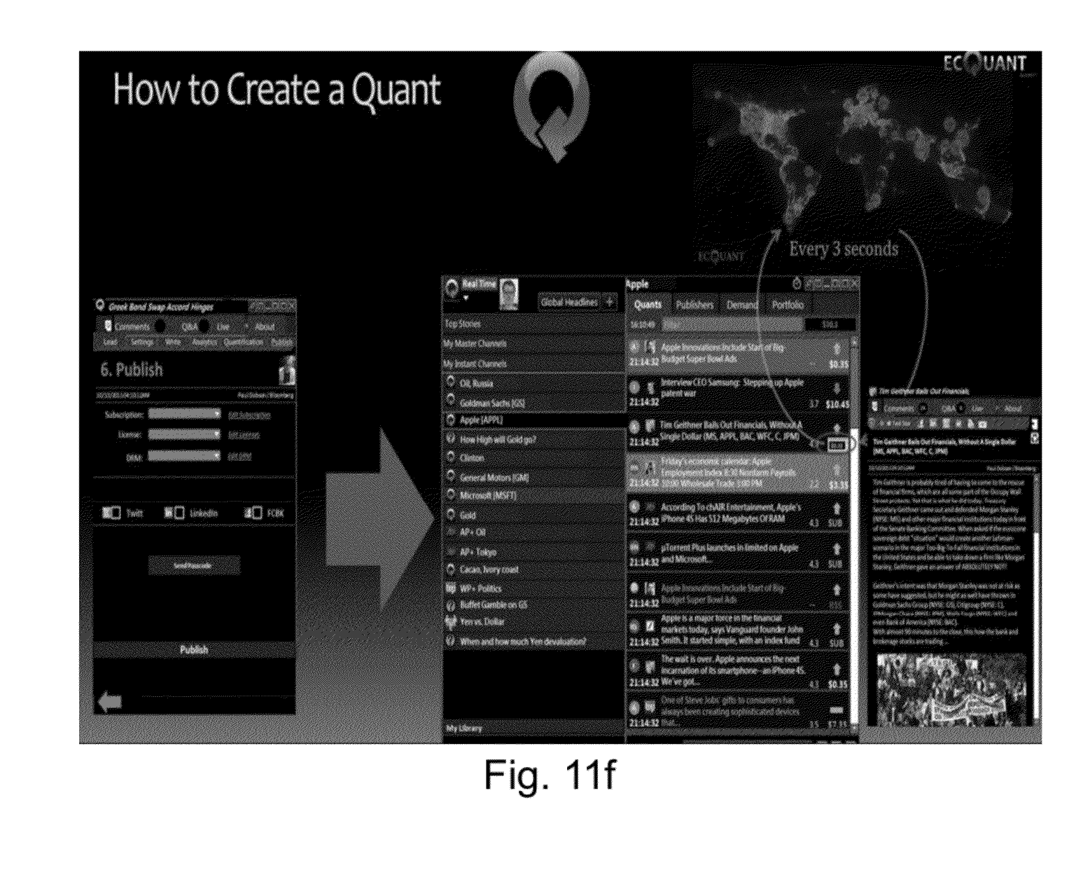

FIGS. 11a through 11f illustrate another example of interaction between a publisher and the system. FIG. 11a illustrates that a publisher can start the process by (1) downloading a program called “EcQuant” from the system, (2) entering suitable information for becoming an accredited publisher, such as identity and perhaps credentials information and information regarding financial arrangements with the system, and (3) writing articles for posting by the system or downloading (accessing) articles from the system. FIG. 11b illustrates a screen that the system may download to a publisher's screen after the publisher has submitted an article (that attached a photo) to the system. To the right of the article, the screen contains a stylized world map over which the system displays for the publisher the number of potential users who may be interested in accessing the article, by territory. For example, there are 4,237 potential users in the U.S. East. The system generates this information about potential users by analyzing the article and its attributes and by using historical information about past behavior of users, through the use of scripts that act as a computer-implemented expert system operating in the pricing engine of the system described in this patent specification. It will be appreciated that as the system grows and adds more publishers and articles, and gains more experience with actual usage of the articles, its estimates of potential users are likely to become more accurate or at least more useful as the scripts are refined based on experience and as more historical information on user behavior is assembled. A display such as illustrated in FIG. 11b may help the publisher make an initial decision of an initial value to place on the article. FIG. 11c illustrates how the price for access to the article may vary over time as the system resets it from time to time through the pricing engine. The horizontal axis is time in the graphs in the right-hand portion of FIG. 11c. The vertical axis for the red line is the changing access price, in this case in the range of about $0.40 to about $0.80 over a time interval of about 130 seconds after the posting of the article. The green bars at the bottom illustrate the instantaneous number of users accessing the article. FIG. 11d is similar but pertains to a later time—257 seconds after the article was posted. The graphs in this example show that the price for access to the article peaked about 160 seconds after posting and then declined until it went down to less than $0.20 as the number of users accessing the article declined. FIG. 11d also shows that in this example the cumulative revenue from the article over this time period was over $2,600. FIG. 11e illustrates similar information, in a somewhat different format and for different access prices and a different cumulative revenue from an article, but similarly indicating that the system described in this patent specification changes access prices over time as a function of user behavior in a manner that is believed to reflect the actual values that users place on access to the article. FIG. 11f illustrates a relationship between as screen display that a publisher may see (the left-hand portion of FIG. 11F) and a screen that a user may see. The user's screen shows a listing of channels (topics) in the left column, a listing of articles in the middle column, including an article for which the access price changes every 3 seconds in this example.

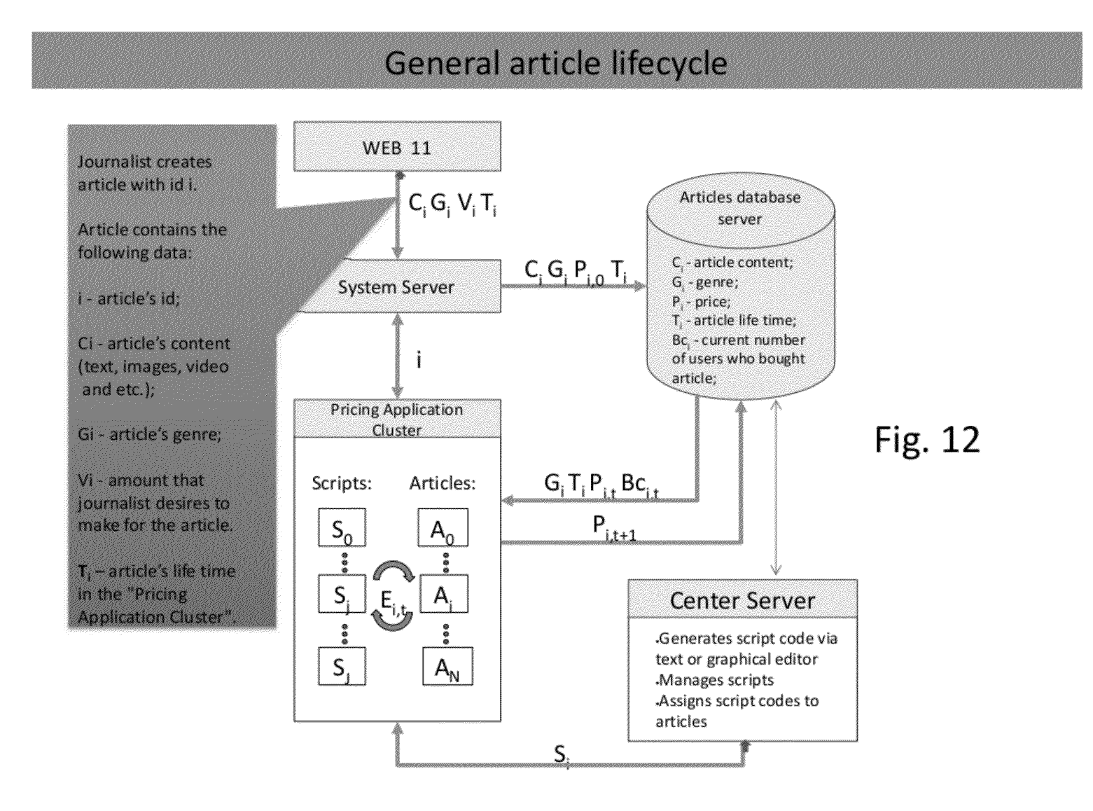

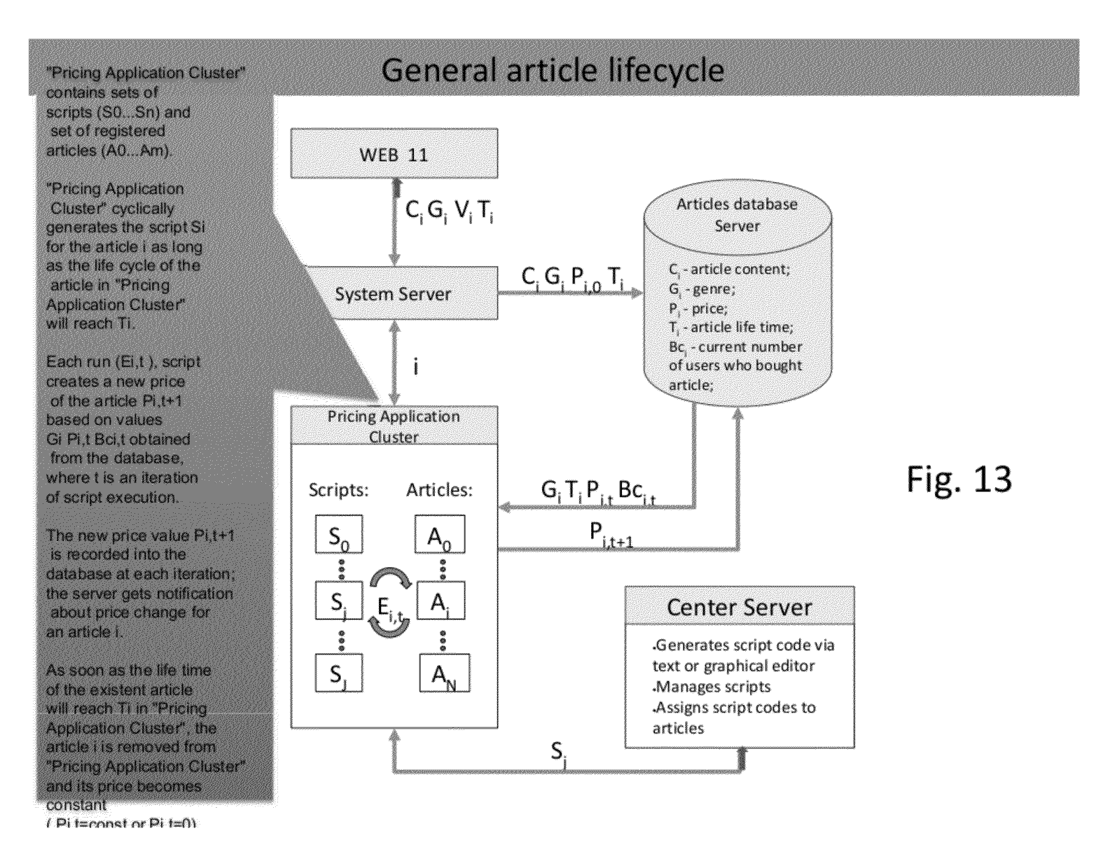

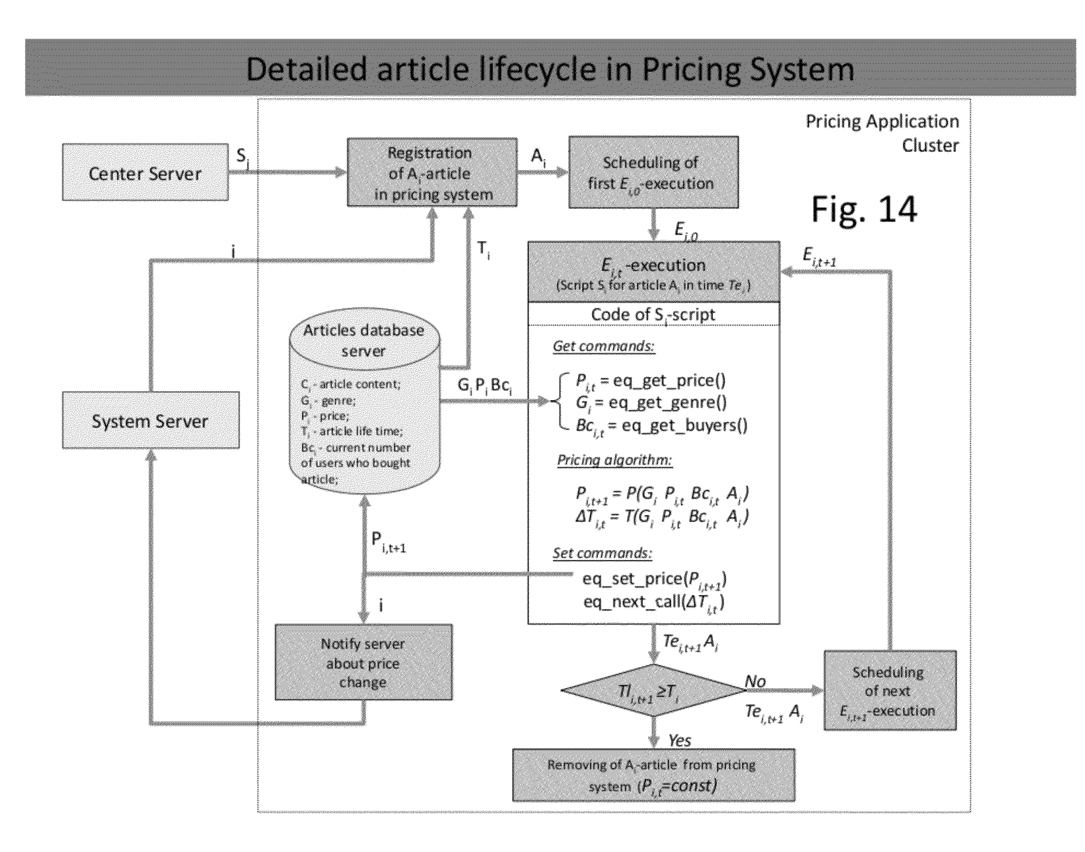

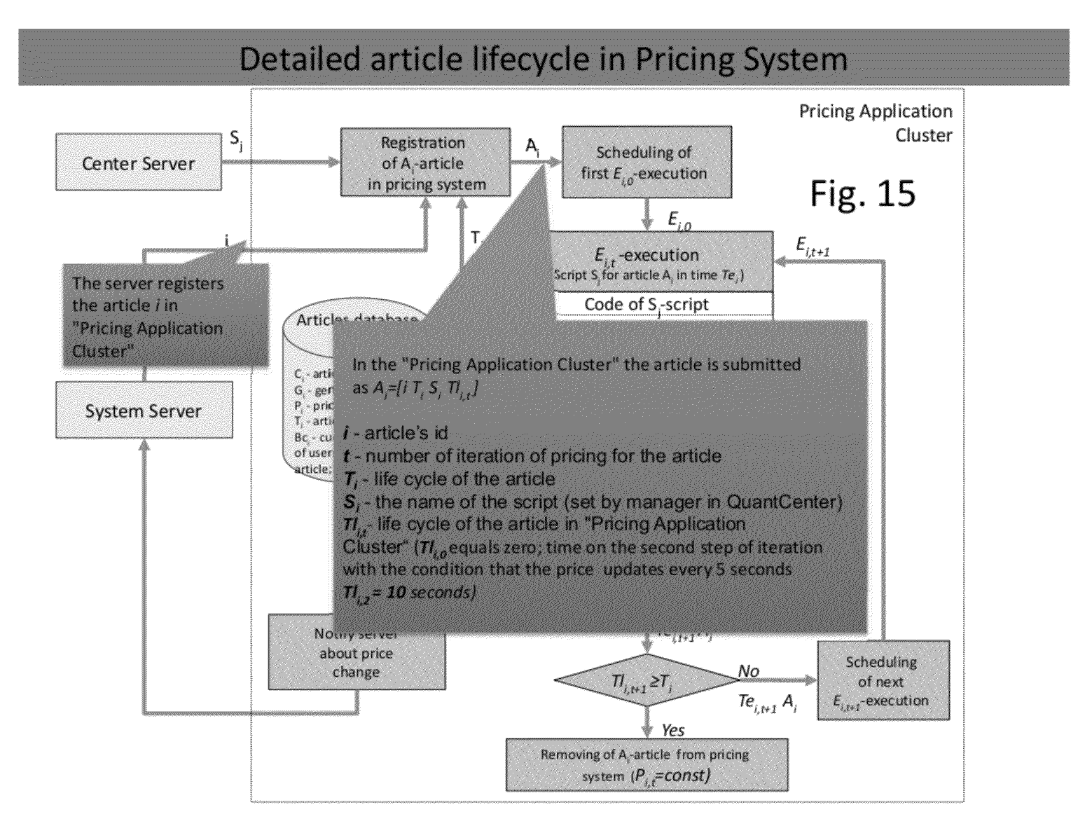

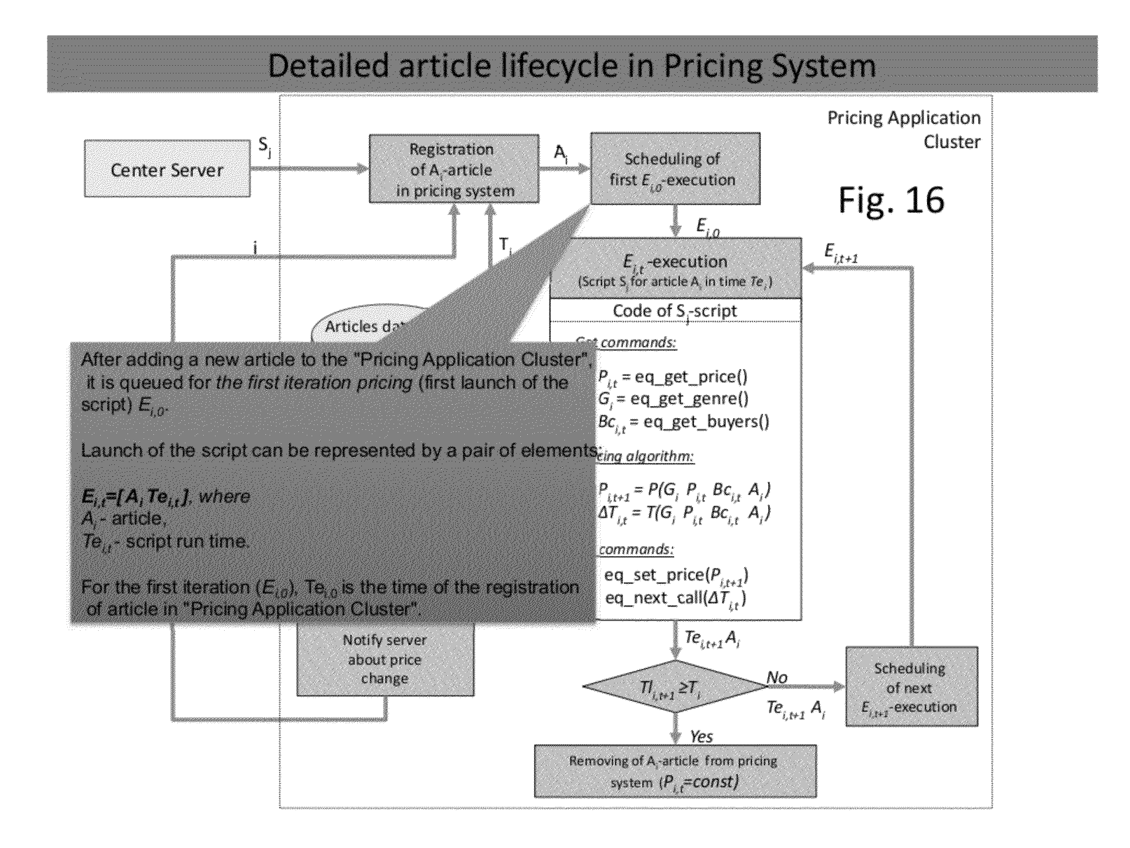

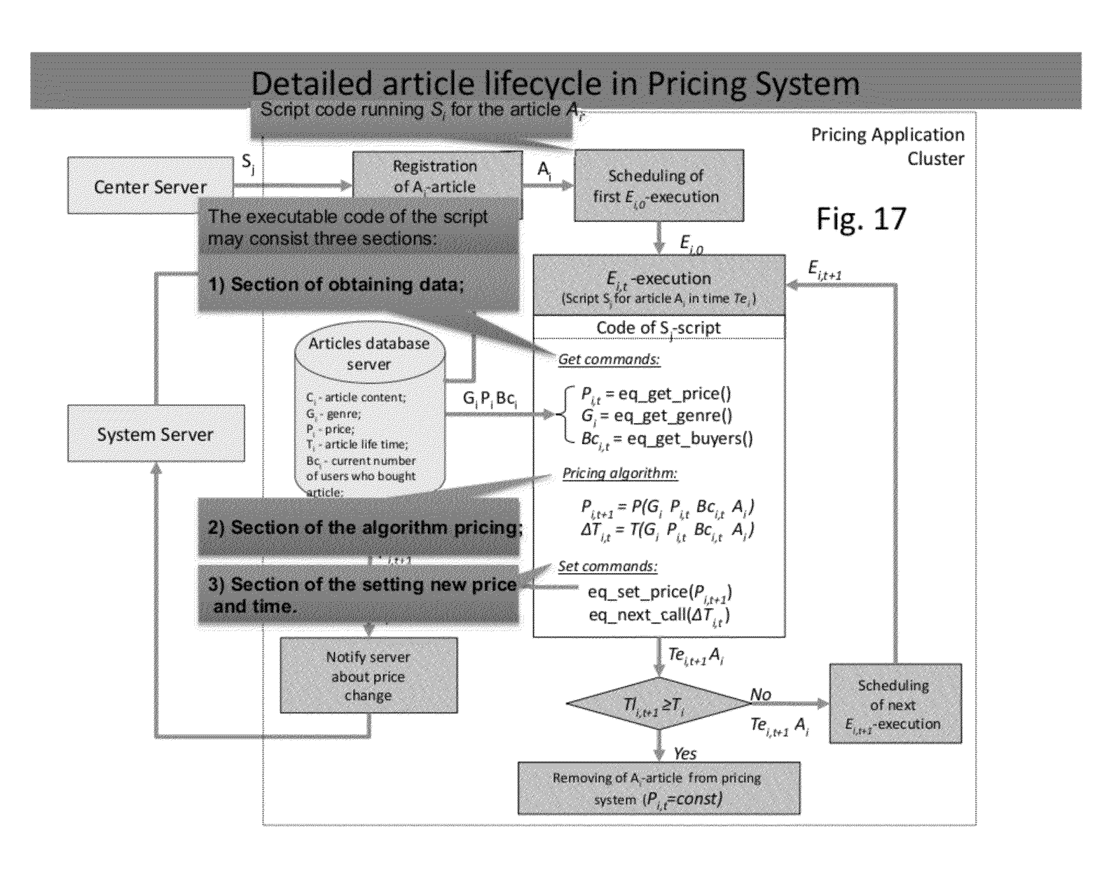

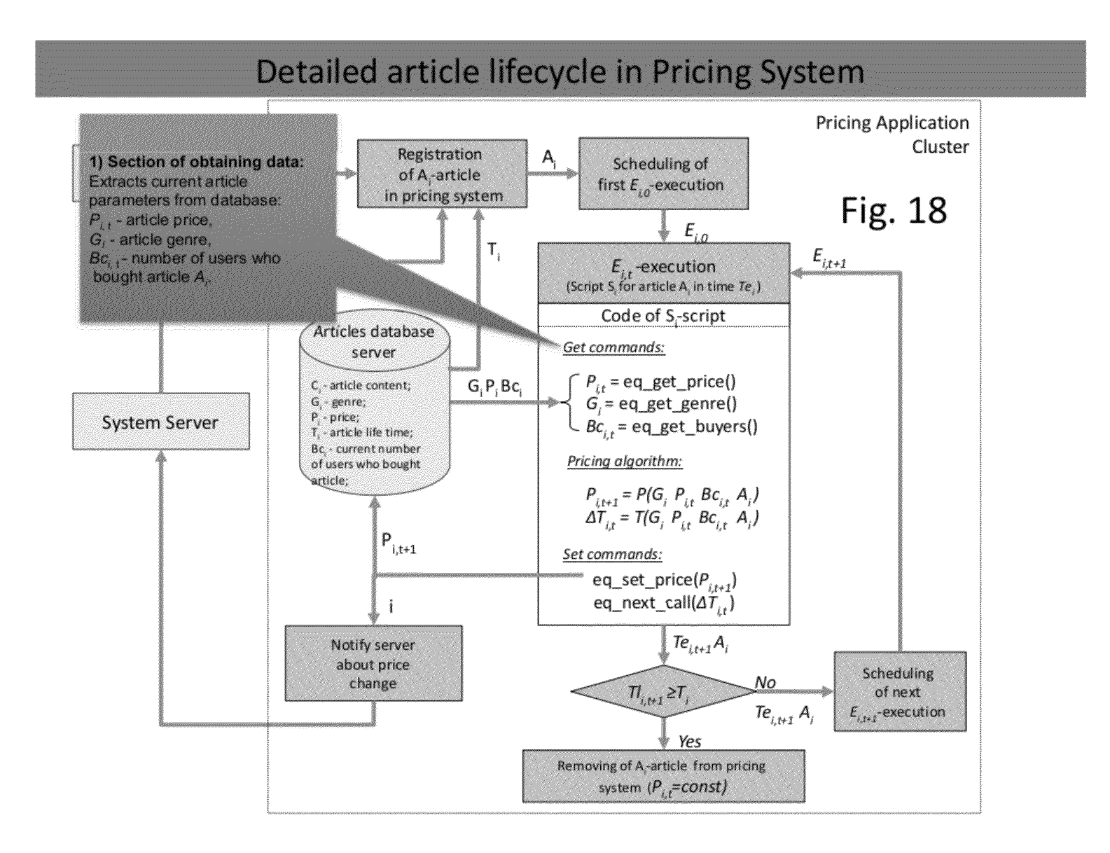

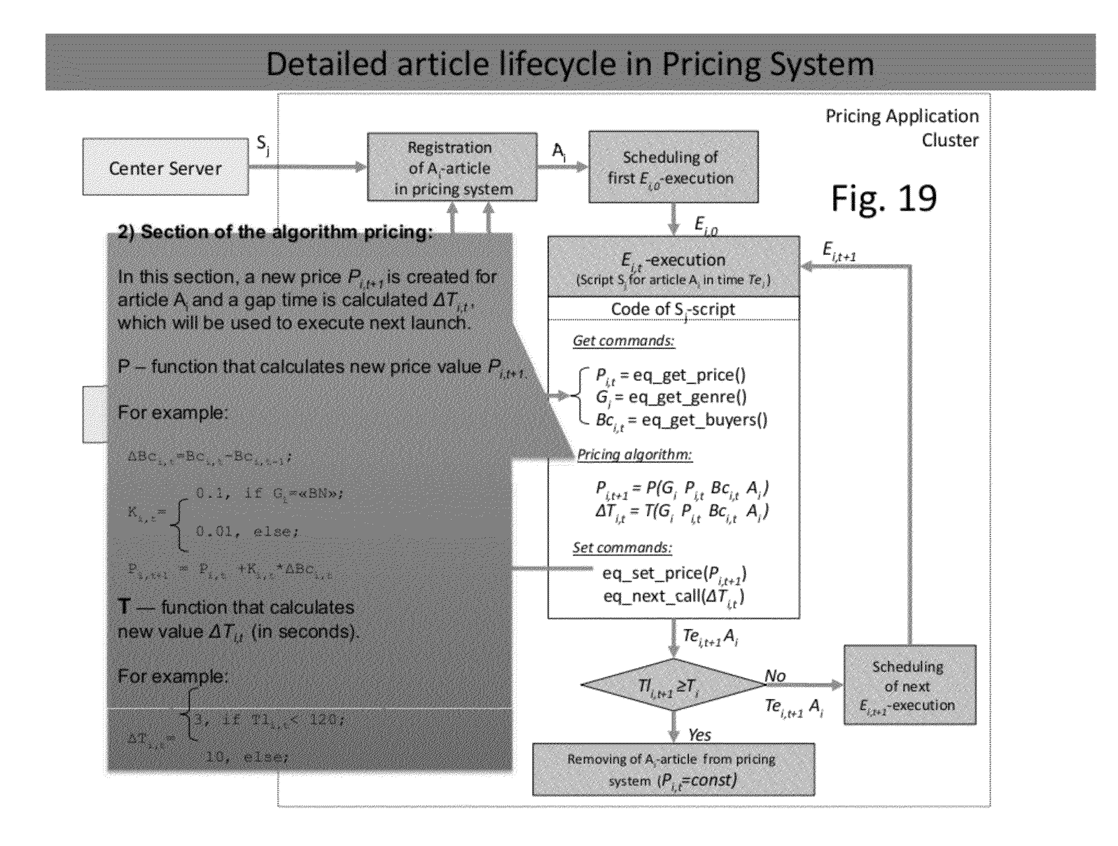

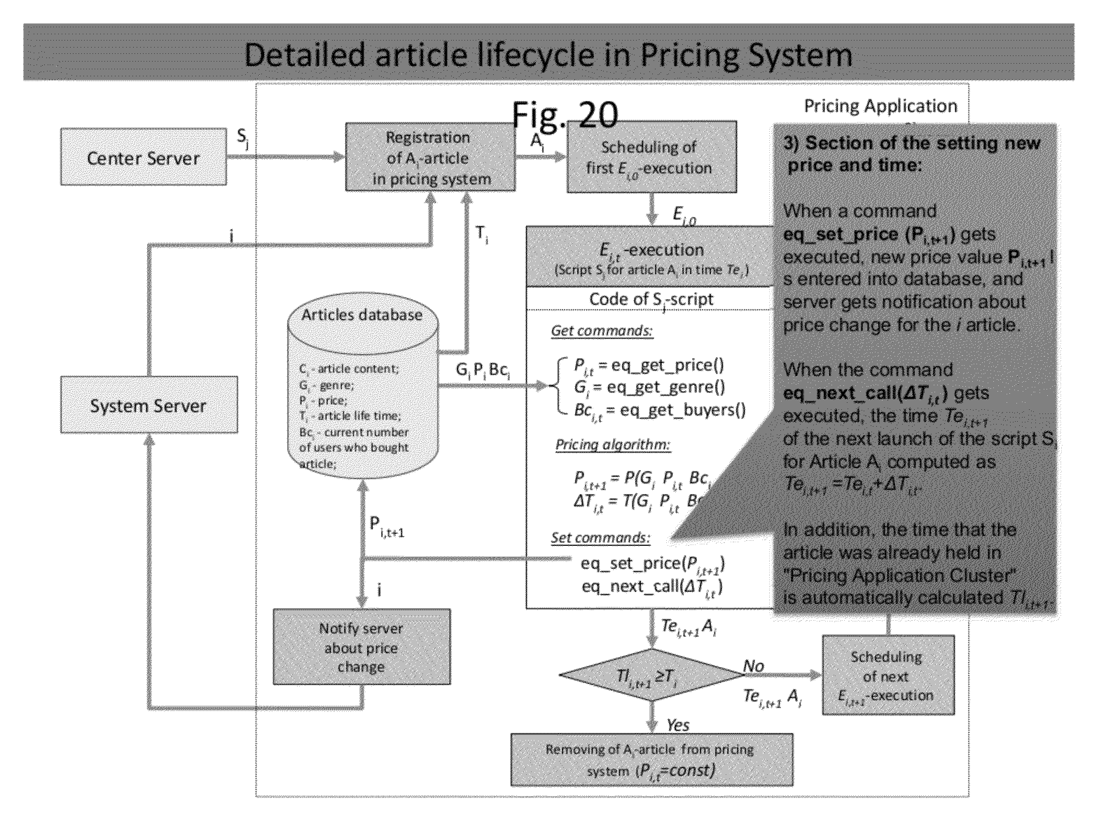

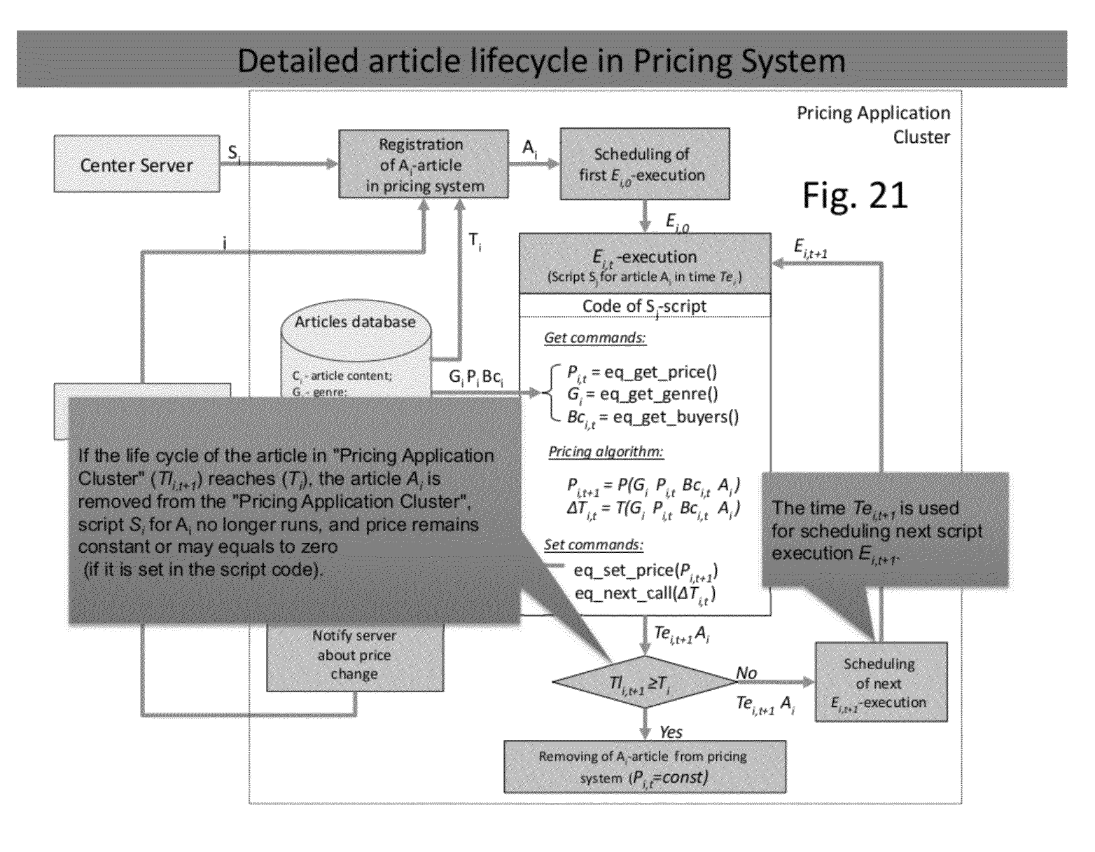

Returning now to the overall operation of the system and method described in this patent specification, FIG. 12 illustrates a portion of the system of FIG. 1 (but does not repeat the reference numbers for identically named components of the system) and in the box on left identifies an example of the information that a publisher such as a journalist provides to the system through the web page that the system downloads to the user's screen. FIG. 13 illustrates the same portion of the system as FIG. 10 but in a different stage of processing the pricing of the article, and in a box on the left illustrates a simple example of factors and parameters that go into the pricing process. FIGS. 14-21 are self-explanatory examples of different stages of the process of pricing access to an article in flowchart format and further illustrate examples of process steps involved in pricing and re-pricing access to articles.

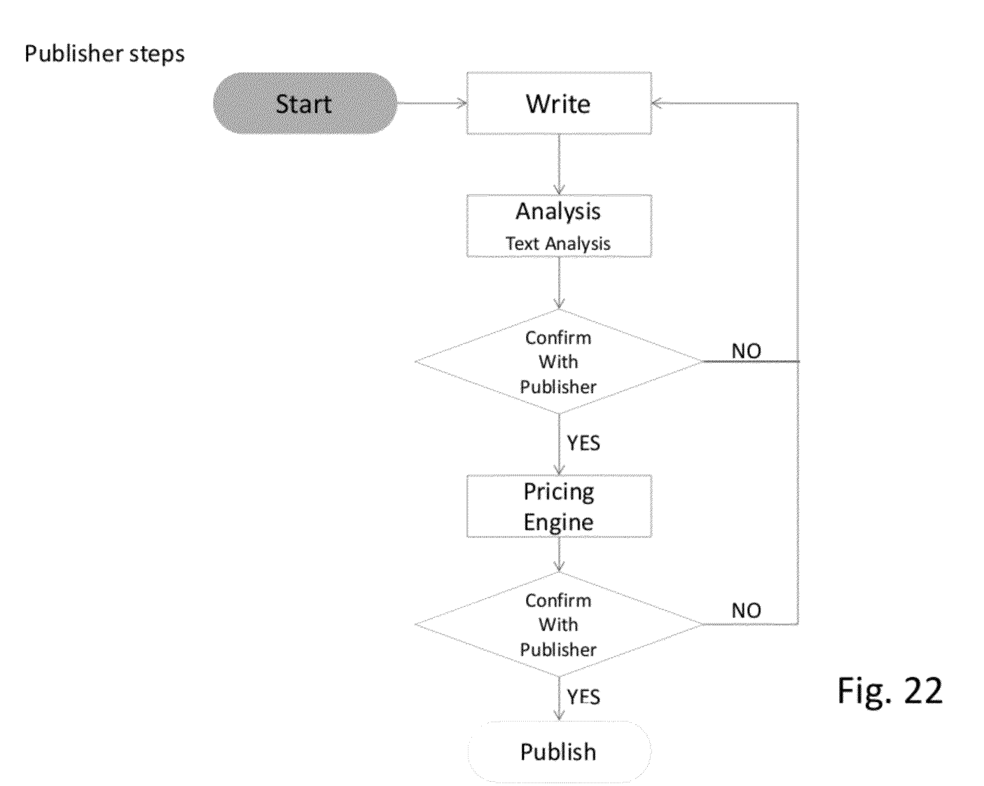

FIG. 22 is a flowchart illustrating an example of some of the steps in an interaction between a publisher and the system. Following the step labeled Start, in which some of the interactions that were described above take place, in the step labeled Write the publisher submits the article and initial information such as keywords. In the step labeled Analysis, the system carries out text analysis and other processing of the submitted article and sends back to the publisher's screen the resulting possibly changes keywords and other information about the article. In the test labeled Confirm With Publisher the system checks whether the publisher has confirmed these changes. If the answer is NO, the system iterates until it has received confirmation from the publisher at this stage, and the answer in the test is YES. In the step labeled Pricing Engine, the pricing engine described above applies scripts and generated pricing information, which also is sent back to the publisher's screen so that another test labeled Confirm With Publisher can be carried out, possibly with iterations until the answer in this second test is YES, and the system can proceed with posting (publishing) the article.

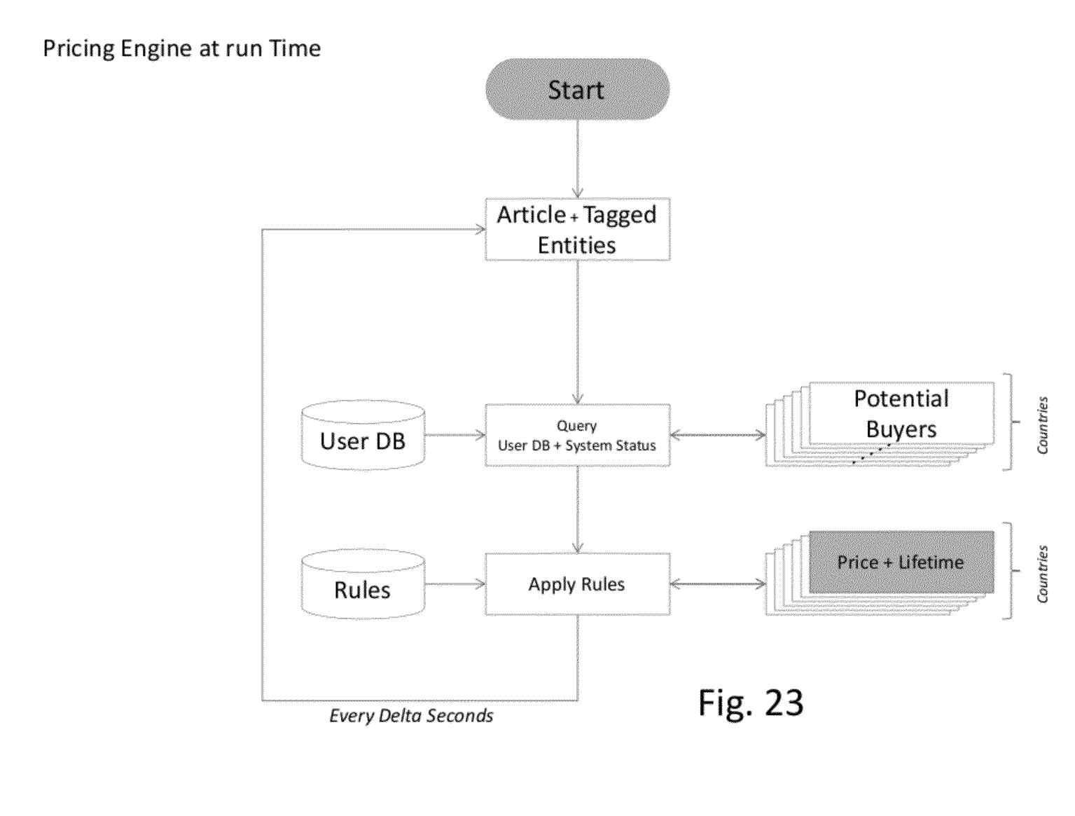

FIG. 23 is a flowchart illustrating an example of steps in the operation of a pricing engine, and follows the process of FIG. 22. Following preliminary operations in the step labeled Start, in the step labeled Article+Tagged Entities the system stores the article that the publisher has submitted as well as information about the article, such as initial value assigned to the article, keywords, genre, etc. (collectively called Tagged Entities in FIG. 23). In the step labeled Query, the pricing engine collects the information pertaining to the article to which scripts will be applied, for example from the storage labeled User DB, and also collects information regarding Potential Buyers (i.e., users), and supplies this information to the step labeled Apply Rules, where scripts of the type discussed above are applied in order to generate current prices for access to the article. This application of scripts uses information from a source labeled Rules (which is a source of scripts) and information labeled Price+Lifetime. At time intervals labeled Every Delta Seconds, the system sends updated prices (or an updated single price) back to the step labeled Article+Tagged Entities, where the updated pricing information is stored for use in the next iteration through the process illustrated in FIG. 23.

It should be understood that while separate servers and processors are illustrated related to different functions of the system, these functions can be distributed differently among one or more servers and processors that can be at the same location or at different locations, or can all be performed in one server or server cluster or processor, consistent with the operation of the system and carrying out the functions described above. Similarly, the articles database server functionality can be in one place or distributed among different places and devices. Therefore, references to servers in this patent specification and claims should be understood to be based on functions rather than on a physical devices or locations.

An application program that interacts with publishers and users, and with one or more servers, to carry out an example of the process described above can be incorporated in or used through an operating system such as Windows from Microsoft, or can be made accessible through browsers, or made available to publishers or users in some other way. A suitable program can be loaded on publishers' and/or users' devices to facilitate interaction with system server 16, or similar interaction can be provided solely through pre-existing facilities of the devices that publishers/users operate, or through a cloud arrangement. A specific program can be written, or a specific programmed system can be assembled, without undue experimentation, according to the description above, to implement an example of the disclosed method and system adapted for a particular setting and/or to meet particular goals.

1. A computer-implemented system configured to provide dynamic, essentially real time pricing of users' access to content represented by articles, said pricing varying over time with user behavior to reflect actual values users that place at any one time on access to the articles, said system comprising:
a computer-implemented system server, a computer-implemented articles database server selectively coupled with the system server for exchange of information therewith, and a computer-implemented pricing engine selectively coupled with the system server and the articles database server for exchange of information therewith;
said system service being configured to selectively communicate with remotely located publishers to receive therefrom articles Ai, where i is an index uniquely identifying a respective article, and initial parameters related thereto and to selectively communicate with remotely located users to send thereto selected articles Ai and repeatedly updated pricing information Pi,t, where i is an index relating the pricing information to respective articles Ai and t denotes time, and to collect user behavior information;
said system server being further configured to process said initial parameters into processed parameter and to send the articles received from the publishers and said processed parameters and said user behavior information to said articles database server;
said articles database server being configured to receive from the system server and to store said articles, processed parameters and user behavior information, to supply the processed parameters and selected portions of the user behavior information to said pricing engine;
said pricing engine being configured to receive said processed parameters and said selected portions of the user behavior information from the articles database server and to repeatedly apply thereto selected scripts and thereby generate and supply to the system server said repeatedly updated pricing information Pi,t;
whereby said generation of the updated pricing information Pi,t, approaches values that said users place on access to the articles Ai at time t.

2. The system of claim 1 in which said pricing engine is further configured to provide different access prices and different delivery schedules for different categories of said users.

3. The system of claim 2 in which said pricing engine is further configured to allow an operator of the system to provide free access to a first category of said articles on first selected terms to a first category of said users while charging other users for access to other articles on other selected terms.

4. The system of claim 3 in which said pricing engine is further configured to include in said first selected terms a selected delay in access to the articles.

5. The system of claim 1 in which said pricing engine is further configured to provide access to a second selected category of said articles to a second category of users on second selected terms that include charging the second category of users said variable prices for access to said second category of articles for at least selected time periods assigned to the respective articles.

6. The system of claim 1 in which said pricing engine is further configured to provide access to a third category of users to a third category of said articles on a third set of terms that enable access to the articles on a subscription basis.

7. The system of claim 6 in which said pricing engine is further configured to provide access to said articles on different subsets of said terms to different subcategories of said third category of users on a different subscription basis.

8. The system of claim 1 in which said pricing engine is further configured to allow an operator of the system to allow to bids for exclusive or non-exclusive transfers of said articles to bidding entities, and to determine said variable prices for access to said articles at least in part on the basis of information related to said transfers.

9. The system of claim 1 in which said pricing engine is further configured to determine said variable prices of articles on the basis of information including previous access to said articles by said users and estimates of potential access to the articles.

10. A pricing engine for a computer-implemented system configured to provide dynamic, essentially real time pricing of users' access to content represented by articles, said pricing varying over time with user behavior to reflect actual values that users place on access to said articles, said pricing engine comprising:
a computer-implemented pricing application cluster configured to apply scripts to articles maintained in an articles database server to thereby iteratively generate variable access prices for the respective articles;
said pricing engine being further configured to receive selected parameters related to the respective articles and updated scripts for applying to the articles;
said parameters comprising parameters related to the extent of potential access to said articles and the extent of previous access to the articles at each of a succession of different times;
said pricing engine being further configured to generate said prices for access to the articles at each of said different times to thereby generate said variable prices; and
said pricing engine being further configured to supply said variable prices for charging said users for access to the respective articles.

11. An computer-implemented articles database server for a system configured to provide dynamic, essentially real time pricing of users' access to content represented by articles, said pricing varying over with user behavior to reflect actual values that users place at any one time on access to the articles, said articles database server comprising:
a computer-implemented database server facility configured to receive and store said articles and initial parameters supplied thereto from publishers at remote locations;
said articles database server facility being further configured to receive and store user behavior information and supply at least some of the received user behavior information for use in generating updated pricing related to said articles; and
said database server facility being further configured to repeatedly receive and store updated user behavior information and supply at least some of the received updated user behavior information for use in generating said updated pricing for access by users to the respective articles.

12. A method of providing articles to and accessing articles through a computer-implemented system configured to provide dynamic, essentially real time pricing of users' access to content represented by articles, said pricing varying over time with user behavior to reflect actual values that users place at any one time on access to the articles, said system comprising, and said method comprising:
establishing communication links of publishers and users at remote locations with said system, said publishers and users operating devices with display screens at said remote locations;
receiving at the devices downloads of screen displays that include provisions for entries through interaction with said screen display that identify publisher and users through said links;
sending articles from said remote devices and initial information regarding the article in case of an identification of publishers through said screen displays and, on the case of identification of a user through said screen displays, receiving and displaying screen downloads at said remote devices with information regarding articles that are accessible through said link from said remote device, a listing of channels into which said articles are categorized, and article pricing that dynamically varies to change from time to time;
selecting through entries at said remote devices categories of access to the articles and channels; and
receiving and displaying the selected articles at said remote devices.
